(19) United States
(12) Patent Application Publication
(10) Pub. No.: US 2016/0379231 A1
(43) Pub. Date: Dec. 29, 2016

(54) DETERMINING RATINGS DATA FROM POPULATION SAMPLE DATA HAVING UNRELIABLE DEMOGRAPHIC CLASSIFICATIONS

(71) Applicant: The Nielsen Company (US), LLC, New York, NY (US)

(72) Inventors: Michael Sheppard, Brooklyn, NY (US); Jonathan Sullivan, Natick, MA (US); Albert Ronald Perez, Beaverton, OR (US); Alejandro Terrazas, Santa Cruz, CA (US)

(21) Appl. No.: 14/752,300

(22) Filed: Jun. 26, 2015

(51) Int. Cl. G06Q 30/02; G06N 7/00

(52) U.S. Cl. CPC G06Q 30/0204; G06N 7/005

(57) ABSTRACT

Example methods disclosed herein to determine ratings data for media exposure include accessing sets of classification probabilities for respective individuals in a sample population exposed to media. In some examples, a first one of the sets of classification probabilities represents likelihoods that a first one of the individuals belongs to respective ones of a set of possible demographic classification. Disclosed example methods also include estimating, based on the sets of classification probabilities, parameters characterizing population attributes associated with the set of possible demographic classifications. Disclosed example methods further include determining the ratings data based on the estimated parameters.

### FIELD OF THE DISCLOSURE

This disclosure relates generally to audience measurement and, more particularly, to determining ratings data from population sample data having unreliable demographic classifications.

### BACKGROUND

Traditionally, audience measurement entities determine compositions of audiences exposed to media by monitoring registered panel members and extrapolating their behavior onto a larger population of interest. That is, an audience measurement entity enrolls people that consent to being monitored into a panel and collects relatively highly accurate demographic information from those panel members via, for example, in-person, telephonic, and/or online interviews. The audience measurement entity then monitors those panel members to determine media exposure information describing media (e.g., television programs, radio programs, movies, streaming media, etc.) exposed to those panel members. By combining the media exposure information with the demographic information for the panel members, and extrapolating the result to the larger population of interest, the audience measurement entity can determine detailed demographic media exposure information identifying, for example, targeted demographic markets for different media.

More recent techniques employed by audience measurement entities to monitoring exposure to Internet accessible media or, more generally, online media expand the available set of monitored individuals to a sample population that may or may not include registered panel members. In some such techniques, demographic information for these monitored individuals can be obtained from one or more database proprietors (e.g., social network sites, multi-service sites, online retailer sites, credit services, etc.) with which the individuals subscribe to receive one or more online services. However, the demographic information available from these database proprietor(s) may be self-reported and, thus, unreliable or less reliable than the demographic information typically obtained for panel members registered by an audience measurement entity.

### BRIEF DESCRIPTION OF THE DRAWINGS

FIG. 1 illustrates example client devices that report audience impressions for Internet-based media to impression collection entities to facilitate identifying numbers of impressions and sizes of audiences exposed to different Internet-based media.

FIG. 2 is an example communication flow diagram illustrating an example manner in which an example audience measurement entity and an example database proprietor can collect impressions and demographic information associated with a client device, and can further determine ratings data from population sample data having unreliable demographic classifications in accordance with the teachings of this disclosure.

FIG. 3 is a block diagram of an example probabilistic ratings determiner that may be included in the example audience measurement entity and/or the example database proprietor of FIGS. 1 and/or 2 to determine ratings data from population sample data having unreliable demographic classifications in accordance with the teachings of this disclosure.

FIG. 4 is a block diagram of an example population attribute parameter estimator that may be used to implement the example probabilistic ratings determiner of FIG. 3.

FIG. 5 is a block diagram of an example ratings data determiner that may be used to implement the example probabilistic ratings determiner of FIG. 3.

FIG. 6 is a flowchart representative of example machine readable instructions that may be executed to implement the example ratings determiner of FIG. 3.

FIG. 7 is a flowchart representative of example machine readable instructions that may be executed to implement the example population attribute parameter estimator of FIG. 4.

FIG. 8 is a flowchart representative of example machine readable instructions that may be executed to implement the example ratings determiner of FIG. 3.

FIG. 9 is a block diagram of an example processor platform structured to execute the example machine readable instructions of FIGS. 6, 7 and/or 8 to implement the example probabilistic ratings determiner of FIG. 3, the example population attribute parameter estimator of FIG. 4 and/or the example ratings determiner of FIG. 5.

Wherever possible, the same reference numbers will be used throughout the drawing(s) and accompanying written description to refer to the same or like parts, elements, etc.

### DETAILED DESCRIPTION

Methods, apparatus, systems and articles of manufacture (e.g., physical storage media) to determine ratings data from population sample data having unreliable demographic classifications are disclosed herein. As mentioned above, audience measurement entities (AMEs) may obtain demographic information for monitored individuals from one or more database proprietors. However, such demographic information may be unreliable, or less reliable than the demographic information typically obtained for panel members registered by an audience measurement entity. Thus, using such demographic information to classify the monitored individuals into different demographic groups may result in unreliable demographic classifications. Example technical solutions disclosed herein address the technical problem of determining ratings data from such population sample data having unreliable demographic classifications.

Example technical solutions disclosed herein utilize sets of classification probabilities to determine ratings data from population sample data having unreliable demographic classifications. To account for the possible unreliability of reported demographic data, some prior online media monitoring techniques determine, for a monitored individual, a set of classification probabilities representing likelihoods that the monitored individual belongs to different classifications in a set of possible classifications. For example, given a monitored individual's reported age (e.g., entered by the individual when subscribing to a database proprietor), some prior online media monitoring techniques process the reported age with other available behavioral data to determine a set of classification probabilities, which include, for example, a first classification probability that the monitored individual belongs to a first age classification (e.g., a first age group, such as a group including ages less than 18 years old), a second classification probability that the monitored individual belongs to a second age classification (e.g., a second age group, such as a group including ages from 18 years old to 34 years old), a third classification probability that the monitored individual belongs to a third age classification (e.g., a third age group, such as a group including ages from 34 years old to 45 years old), and so on. Example technical solutions disclosed herein go further and process the sets of classification probabilities obtained for monitored individuals to estimate parameters characterizing population attributes associated with the set of possible demographic classifications. Some such disclosed example solutions then determine ratings data for media exposure based on the estimated parameters.

For example, some example methods disclosed herein to determine ratings data for media exposure include accessing sets of classification probabilities for respective individuals in a sample population exposed to media. In some examples, a first one of the sets of classification probabilities represents likelihoods that a first one of the individuals belongs to respective ones of a set of possible demographic classifications. For example, the first one of the sets of classification probabilities may include a first probability that the first one of the individuals belongs to a first one of the set of possible demographic classifications (e.g., a first age classification, such as a first age group), a second probability that the first one of the individuals belongs to a second one of the set of possible demographic classifications (e.g., a second age classification, such as a second age group), etc. Disclosed example methods also include estimating, based on the sets of classification probabilities, parameters characterizing population attributes associated with the set of possible demographic classifications. Disclosed example methods further include determining the ratings data based on the estimated parameters.

In some disclosed example methods, the parameters include average values for the population attributes associated with respective ones of the set of possible demographic classifications. In some disclosed examples, the parameters additionally or alternatively include variance values for the population attributes associated with the respective ones of the set of possible demographic classifications. In some disclosed examples, the parameters additionally or alternatively include covariance values for the population attributes associated with respective pairs of the set of possible demographic classifications.

For example, in some such disclosed example methods, estimating the parameters includes summing first quantities based on first classification probabilities, from the sets of classification probabilities, representing likelihoods that the respective individuals belong to a first one of the set of possible demographic classifications to estimate a first average value for a first population attribute associated with the first one of the set of possible demographic classifications. In some such disclosed example methods, estimating the parameters additionally or alternatively includes summing second quantities based on the first classification probabilities to estimate a first variance value for the first population attribute associated with the first one of the set of possible demographic classifications. In some such disclosed example methods, estimating the parameters additionally or alternatively includes summing third quantities based on the first classification probabilities and second classification probabilities, from the sets of classification probabilities, representing likelihoods that the respective individuals belong to a second one of the set of possible demographic classifications to estimate a first covariance value for a first pair of population attributes associated with the first and second ones of the set of possible demographic classifications.

Additionally or alternatively, in some such disclosed example methods, estimating the parameters includes forming a covariance matrix based on the variance values and the covariance values. In some such disclosed example methods, determining the ratings data includes using the average values and the covariance matrix to evaluate an expression based on a multivariate normal distribution to determine the ratings data.

Additionally or alternatively, in some disclosed example methods, the population attributes associated with the set of possible demographic classification include at least one of (1) numbers of individuals associated with respective ones of the set of possible demographic classifications or (2) numbers of media impressions associated with the respective ones of the set of possible demographic classifications. In some such disclosed example methods, determining the ratings data includes one or more of (i) determining, based on the estimated parameters, a probability that a number of individuals associated with a first one of the set of possible demographic classifications is at least one of less than or greater than a value; (ii) determining, based on the estimated parameters, a confidence interval for a number of media impressions associated with the first one of the set of possible demographic classifications; and/or (iii) determining, based on the estimated parameters, a probability that the number of media impressions associated with the first one of the set of possible demographic classifications is at least one of less than or greater than a combined number of media impressions associated with a combination of at least a second one and a third one of the set of possible demographic classifications. In some examples, determining the ratings data includes determining, based on the estimated parameters, a probability that the combined population attribute(s) associated with a first combination (e.g., a linear combination, which may have integer and/or non-integer coefficients) of a first group of possible demographic classifications is greater than, less than or equal to the combined population attribute(s) associated with a second combination (e.g., a linear combination, which may have integer and/or non-integer coefficients) of a second group of possible demographic classifications (e.g., different from the first group).

Additionally or alternatively, in some such disclosed example methods, determining the ratings data includes determining, based on the estimated parameters, at least one of (a) average numbers of individuals associated with the respective ones of the set of possible demographic classifications or (b) average numbers of media impressions associated with the respective ones of the set of possible demographic classifications to include in the ratings data. Some such disclosed example method also include determining, based on the estimated parameters, statistical values characterizing accuracy (or, more generally, one or more properties) of the least one of the determined average numbers of individuals associated with the respective ones of the set of possible demographic classifications or the determined average numbers of media impressions associated with the respective ones of the set of possible demographic classifications to include in the ratings data. Some such disclosed example methods further include transmitting the ratings data electronically to a provider of the media.

These and other example methods, apparatus, systems and articles of manufacture (e.g., physical storage media) to determine ratings data from population sample data having unreliable demographic classifications are disclosed in greater detail below.

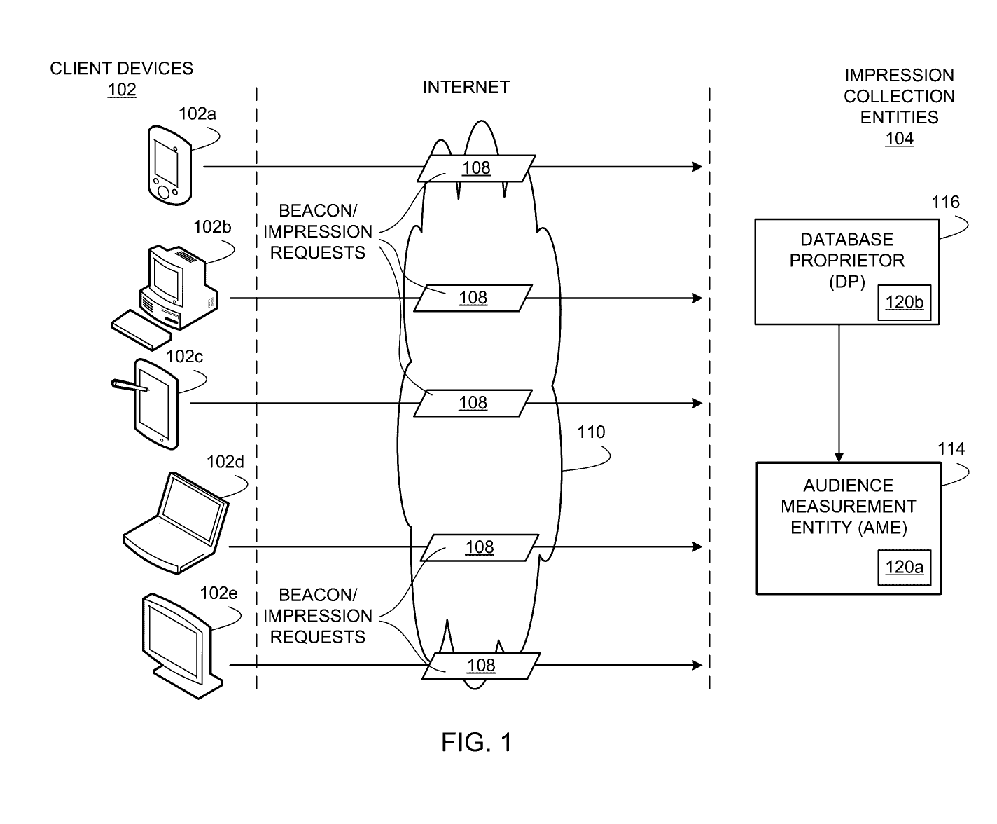

Turning to the figures, FIG. 1 illustrates example client devices 102 that report audience impressions for online (e.g., Internet-based) media to impression collection entities 104 to facilitate determining numbers of impressions and sizes of audiences exposed to different online media. An impression generally refers to an instance of an individual's exposure to media (e.g., content, advertising, etc.). As used herein, the term impression collection entity refers to any entity that collects impression data, such as, for example, audience measurement entities and database proprietors that collect impression data.

The client devices 102 of the illustrated example may be any device capable of accessing media over a network. For example, the client devices 102 may be a computer, a tablet, a mobile device, a smart television, or any other Internet-capable device or appliance. Examples disclosed herein may be used to collect impression information for any type of media, including content and/or advertisements. Media may include advertising and/or content delivered via web pages, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming). Traditionally, content is provided at little or no cost to the audience because it is subsidized by advertisers that pay to have their advertisements distributed with the content. As used herein, “media” refers collectively and/or individually to content and/or advertisement(s).

In the illustrated example, the client devices 102 employ web browsers and/or applications (e.g., apps) to access media, some of which include instructions that cause the client devices 102 to report media monitoring information to one or more of the impression collection entities 104. That is, when a client device 102 of the illustrated example accesses media, a web browser and/or application of the client device 102 executes one or more instructions (e.g., beacon instruction(s)) in the media, which cause the client device 102 to send a beacon request or impression request 108 to one or more impression collection entities 104 via, for example, the Internet 110. The beacon requests 108 of the illustrated example include information about accesses to media at the corresponding client device(s) 102 generating the beacon requests. Such beacon requests allow monitoring entities, such as the impression collection entities 104, to collect impressions for different media accessed via the client devices 102. In this manner, the impression collection entities 104 can generate large impression quantities for different media (e.g., different content and/or advertisement campaigns). Examples techniques for using beacon instructions and beacon requests to cause devices to collect impressions for different media accessed via client devices are further disclosed in at least U.S. Pat. No. 6,108,637 to Blumenau and U.S. Pat. No. 8,370,489 to Mainak, et al., which are incorporated herein by reference in their respective entireties.

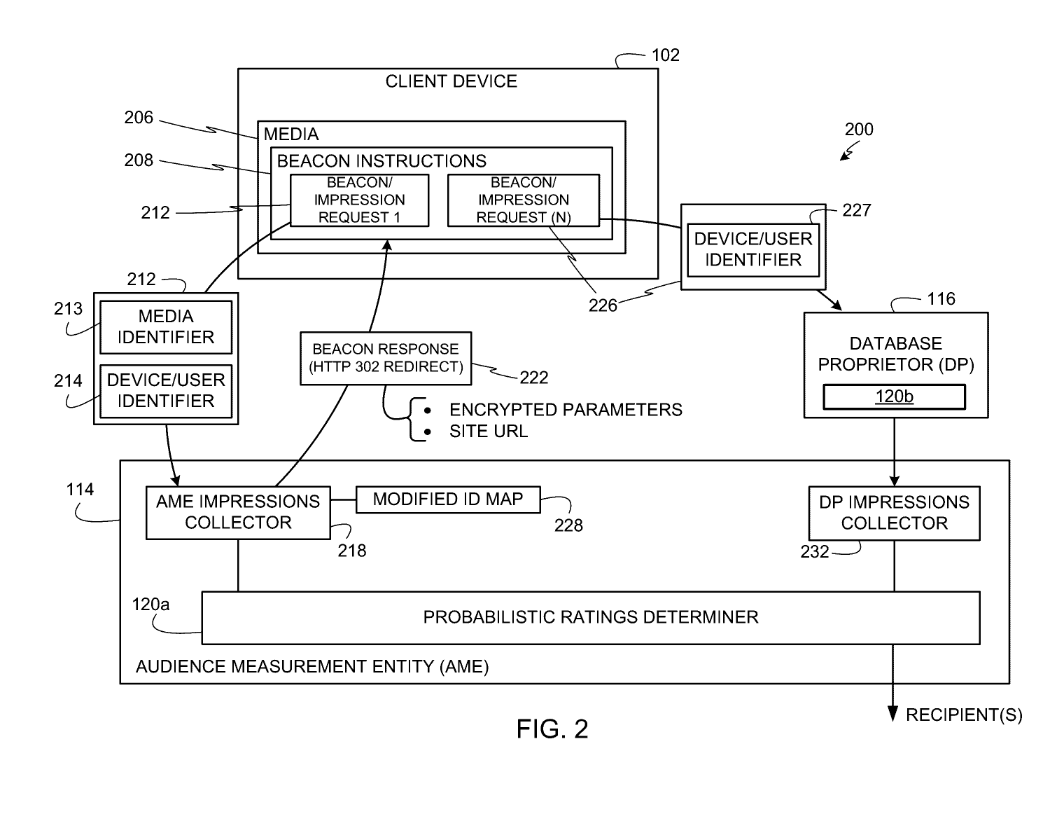

The impression collection entities 104 of the illustrated example include an example audience measurement entity (AME) 114 and an example database proprietor (DP) 116. In the illustrated example, the AME 114 does not provide the media to the client devices 102 and is a trusted (e.g., neutral) third party (e.g., The Nielsen Company, LLC) for providing accurate media access statistics. In the illustrated example, the database proprietor 116 is one of many database proprietors that operate on the Internet to provide services to large numbers of subscribers. Such services may include, but are not limited to, email services, social networking services, news media services, cloud storage services, streaming music services, streaming video services, online retail shopping services, credit monitoring services, etc. Example database proprietors include social network sites (e.g., Facebook, Twitter, MySpace, etc.), multi-service sites (e.g., Yahoo!, Google, etc.), online retailer sites (e.g., Amazon.com, Buy.com, etc.), credit services (e.g., Experian), and/or any other web service(s) site that maintains user registration records. In examples disclosed herein, the database proprietor 116 maintains user account records corresponding to users registered for Internet-based services provided by the database proprietors. That is, in exchange for the provision of services, subscribers register with the database proprietor 116. As part of this registration, the subscribers provide detailed demographic information to the database proprietor 116. Demographic information may include, for example, gender, age, ethnicity, income, home location, education level, occupation, etc. In the illustrated example, the database proprietor 116 sets a device/user identifier (e.g., an identifier described below in connection with FIG. 2) on a subscriber's client device 102 that enables the database proprietor 116 to identify the subscriber.

In the illustrated example, when the database proprietor 116 receives a beacon/impression request 108 from a client device 102, the database proprietor 116 requests the client device 102 to provide the device/user identifier that the database proprietor 116 had previously set for the client device 102. The database proprietor 116 uses the device/user identifier corresponding to the client device 102 to identify demographic information in its user account records corresponding to the subscriber of the client device 102. In this manner, the database proprietor 116 can generate demographic impressions by associating demographic information with an audience impression for the media accessed at the client device 102. Thus, as used herein, a demographic impression is an impression that is associated with a characteristic (e.g., a demographic characteristic) of the person exposed to the media. Through the use of demographic impressions, which associate monitored (e.g., logged) impressions with demographic information, it is possible to measure media exposure and, by extension, infer media consumption behaviors across different demographic classifications (e.g., groups) of a sample population of individuals.

In the illustrated example, the AME 114 establishes a panel of users who have agreed to provide their demographic information and to have their Internet browsing activities monitored. When an individual joins the AME panel, the person provides detailed information concerning the person's identity and demographics (e.g., gender, age, ethnicity, income, home location, occupation, etc.) to the AME 114. The AME 114 sets a device/user identifier (e.g., an identifier described below in connection with FIG. 2) on the person's client device 102 that enables the AME 114 to identify the panelist.

In the illustrated example, when the AME 114 receives a beacon request 108 from a client device 102, the AME 114 requests the client device 102 to provide the AME 114 with the device/user identifier the AME 114 previously set for the client device 102. The AME 114 uses the device/user identifier corresponding to the client device 102 to identify demographic information in its user AME panelist records corresponding to the panelist of the client device 102. In this manner, the AME 114 can generate demographic impressions by associating demographic information with an audience impression for the media accessed at the client device 102.

In the illustrated example, the database proprietor 116 reports demographic impression data to the AME 114. To preserve the anonymity of its subscribers, the demographic impression data may be anonymous demographic impression data and/or aggregated demographic impression data. In the case of anonymous demographic impression data, the database proprietor 116 reports user-level demographic impression data (e.g., which is resolvable to individual subscribers), but with any personal identification information removed from or obfuscated (e.g., scrambled, hashed, encrypted, etc.) in the reported demographic impression data. For example, anonymous demographic impression data, if reported by the database proprietor 116 to the AME 114, may include respective demographic impression data for each device 102 from which a beacon request 108 was received, but with any personal identification information removed from or obfuscated in the reported demographic impression data. In the case of aggregated demographic impression data, individuals are grouped into different demographic classifications, and aggregate demographic impression data (e.g., which is not resolvable to individual subscribers) for the respective demographic classifications is reported to the AME 114. For example, aggregate demographic impression data, if reported by the database proprietor 116 to the AME 114, may include first demographic impression data aggregated for devices 102 associated with demographic information belonging to a first demographic classification (e.g., a first age group, such as a group which includes ages less than 18 years old), second demographic impression data for devices 102 associated with demographic information belonging to a second demographic classification (e.g., a second age group, such as a group which includes ages from 18 years old to 34 years old), etc.

As mentioned above, demographic information available for subscribers of the database proprietor 116 may be unreliable, or less reliable than the demographic information obtained for panel members registered by the AME 114. There are numerous social, psychological and/or online safety reasons why subscribers of the database proprietor 116 may inaccurately represent or even misrepresent their demographic information, such as age, gender, etc. Accordingly, the AME 114 and/or the database proprietor 116 determine sets of classification probabilities for respective individuals in the sample population for which demographic data is collected. A given set of classification probabilities represents likelihoods that a given individual in a sample population belongs to respective ones of a set of possible demographic classifications. For example, the set of classification probabilities determined for a given individual in a sample population may include a first probability that the individual belongs to a first one of possible demographic classifications (e.g., a first age classification, such as a first age group), a second probability that the individual belongs to a second one of the possible demographic classifications (e.g., a second age classification, such as a second age group), etc. In some examples, the AME 114 and/or the database proprietor 116 determine the sets of classification probabilities for individuals of a sample population by combining, with models, decision trees, etc., the individuals' demographic information with other available behavioral data that can be associated with the individuals to estimate, for each individual, the probabilities that the individual belongs to different possible demographic classifications in a set of possible demographic classifications. Examples techniques for reporting demographic impression data from the database proprietor 116 to the AME 114, and for determining sets of classification probabilities representing likelihoods that individuals of a sample population belong to respective possible demographic classifications in a set of possible demographic classifications, are further disclosed in at least U.S. Patent Publication No. 2012/0072469 to Perez et al. and U.S. patent application Ser. No. 14/604,394 (now U.S. Patent Publication No. ______) to Sullivan et al., which are incorporated herein by reference in their respective entireties.

In the illustrated example, one or both of the AME 114 and the database proprietor 116 include example probabilistic ratings determiners to determine ratings data from population sample data having unreliable demographic classifications in accordance with the teachings of this disclosure. For example, the AME 114 may include an example probabilistic ratings determiner 120a and/or the database proprietor 116 may include an example probabilistic ratings determiner 120b. As disclosed in further detail below, the probabilistic ratings determiner 120a and/or 120b of the illustrated example process sets of classification probabilities determined by the AME 114 and/or the database proprietor 116 for monitored individuals of a sample population (e.g., corresponding to a population of individuals associated with the devices 102 from which beacon requests 108 were received) to estimate parameters characterizing population attributes (also referred to herein as population attribute parameters) associated with the set of possible demographic classifications.

In some examples, such as when the probabilistic ratings determiner 120b is implemented at the database proprietor 116, the sets of classification probabilities processed by the probabilistic ratings determiner 120b to estimate the population attribute parameters include personal identification information which permits the sets of classification probabilities to be associated with specific individuals. In some examples, such as when the probabilistic ratings determiner 120a is implemented at the AME 114, the sets of classification probabilities processed by the probabilistic ratings determiner 120a to estimate the population attribute parameters are included in reported, anonymous demographic impression data and, thus, do not include personal identification. However, the sets of classification probabilities can still be associated with respective, but unknown, individuals using, for example, anonymous identifiers (e.g., hashed identifier, scrambled identifiers, encrypted identifiers, etc.) included in the anonymous demographic impression data. In some examples, such as when the probabilistic ratings determiner 120a is implemented at the AME 114, the sets of classification probabilities processed by the probabilistic ratings determiner 120a to estimate the population attribute parameters are included in reported, aggregate demographic impression data and, thus, do not include personal identification and are not associated with respective individuals but, instead, are associated with respective aggregated groups of individuals. For example, the sets of classification probabilities included in the aggregate demographic impression data may include a first set of classification probabilities representing likelihoods that a first aggregated group of individuals belongs to respective possible demographic classifications in a set of possible demographic classifications, a second set of classification probabilities representing likelihoods that a second aggregated group of individuals belongs to the respective possible demographic classifications in the set of possible demographic classifications, etc.

Using the estimated population attribute parameters, the probabilistic ratings determiner 120a and/or 120b of the illustrated example then determine ratings data for media exposure, as disclosed in further detail below. For example, the probabilistic ratings determiner 120a and/or 120b may process the estimated population attribute parameters to further estimate numbers of individuals across different demographic classifications who were exposed to given media, numbers of media impressions across different demographic classifications for the given media, accuracy metrics for the estimate number of individuals and/or numbers of media impressions, etc.

FIG. 2 is an example communication flow diagram 200 illustrating an example manner in which the AME 114 and the database proprietor 116 can collect demographic impressions based on client devices 102 reporting impressions to the AME 114 and the database proprietor 116. FIG. 2 also shows the example probabilistic ratings determiners 120a and 120b, which are able to determine ratings data from population sample data having unreliable demographic classifications in accordance with the teachings of this disclosure. The example chain of events shown in FIG. 2 occurs when a client device 102 accesses media for which the client device 102 reports an impression to the AME 114 and/or the database proprietor 116. In some examples, the client device 102 reports impressions for accessed media based on instructions (e.g., beacon instructions) embedded in the media that instruct the client device 102 (e.g., that instruct a web browser or an app in the client device 102) to send beacon/impression requests (e.g., the beacon/impression requests 108 of FIG. 1) to the AME 114 and/or the database proprietor 116. In such examples, the media having the beacon instructions is referred to as tagged media. In other examples, the client device 102 reports impressions for accessed media based on instructions embedded in apps or web browsers that execute on the client device 102 to send beacon/impression requests (e.g., the beacon/impression requests 108 of FIG. 1) to the AME 114 and/or the database proprietor 116 for corresponding media accessed via those apps or web browsers. In some examples, the beacon/impression requests (e.g., the beacon/impression requests 108 of FIG. 1) include device/user identifiers (e.g., AME IDs and/or DP IDs) as described further below to allow the corresponding AME 114 and/or the corresponding database proprietor 116 to associate demographic information with resulting logged impressions.

In the illustrated example, the client device 102 accesses media 206 that is tagged with beacon instructions 208. The beacon instructions 208 cause the client device 102 to send a beacon/impression request 212 to an AME impressions collector 218 when the client device 102 accesses the media 206. For example, a web browser and/or app of the client device 102 executes the beacon instructions 208 in the media 206 which instruct the browser and/or app to generate and send the beacon/impression request 212. In the illustrated example, the client device 102 sends the beacon/impression request 212 using an HTTP (hypertext transfer protocol) request addressed to the URL (uniform resource locator) of the AME impressions collector 218 at, for example, a first Internet domain of the AME 114. The beacon/impression request 212 of the illustrated example includes a media identifier 213 (e.g., an identifier that can be used to identify content, an advertisement, and/or any other media) corresponding to the media 206. In some examples, the beacon/impression request 212 also includes a site identifier (e.g., a URL) of the website that served the media 206 to the client device 102 and/or a host website ID (e.g., www.acme.com) of the website that displays or presents the media 206. In the illustrated example, the beacon/impression request 212 includes a device/user identifier 214. In the illustrated example, the device/user identifier 214 that the client device 102 provides to the AME impressions collector 218 in the beacon impression request 212 is an AME ID because it corresponds to an identifier that the AME 114 uses to identify a panelist corresponding to the client device 102. In other examples, the client device 102 may not send the device/user identifier 214 until the client device 102 receives a request for the same from a server of the AME 114 in response to, for example, the AME impressions collector 218 receiving the beacon/impression request 212.

In some examples, the device/user identifier 214 may be a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore (where HTML is an abbreviation for hypertext markup language), and/or any other identifier that the AME 114 stores in association with demographic information about users of the client devices 102. In this manner, when the AME 114 receives the device/user identifier 214, the AME 114 can obtain demographic information corresponding to a user of the client device 102 based on the device/user identifier 214 that the AME 114 receives from the client device 102. In some examples, the device/user identifier 214 may be encrypted (e.g., hashed) at the client device 102 so that only an intended final recipient of the device/user identifier 214 can decrypt the hashed identifier 214. For example, if the device/user identifier 214 is a cookie that is set in the client device 102 by the AME 114, the device/user identifier 214 can be hashed so that only the AME 114 can decrypt the device/user identifier 214. If the device/user identifier 214 is an IMEI number, the client device 102 can hash the device/user identifier 214 so that only a wireless carrier (e.g., the database proprietor 116) can decrypt the hashed identifier 214 to recover the IMEI for use in accessing demographic information corresponding to the user of the client device 102. By hashing the device/user identifier 214, an intermediate party (e.g., an intermediate server or entity on the Internet) receiving the beacon request cannot directly identify a user of the client device 102.

In response to receiving the beacon/impression request 212, the AME impressions collector 218 logs an impression for the media 206 by storing the media identifier 213 contained in the beacon/impression request 212. In the illustrated example of FIG. 2, the AME impressions collector 218 also uses the device/user identifier 214 in the beacon/impression request 212 to identify AME panelist demographic information corresponding to a panelist of the client device 102. That is, the device/user identifier 214 matches a user ID of a panelist member (e.g., a panelist corresponding to a panelist profile maintained and/or stored by the AME 114). In this manner, the AME impressions collector 218 can associate the logged impression with demographic information of a panelist corresponding to the client device 102. In some examples, the AME impressions collector 218 determines (e.g., in accordance with the examples disclosed in U.S. Patent Publication No. 2012/0072469 to Perez et al. and/or U.S. patent application Ser. No. 14/604,394 (now U.S. Patent Publication No. ______), etc.) a set of classification probabilities for the panelist to include in the demographic information associated with the logged impression. As described above and in further detail below, the set of classification probabilities represent likelihoods that the panelist belongs to respective ones of a set of possible demographic classifications (e.g., such as likelihoods that the panelist belongs to respective ones of a set of possible age groupings, etc.).

In some examples, the beacon/impression request 212 may not include the device/user identifier 214 if, for example, the user of the client device 102 is not an AME panelist. In such examples, the AME impressions collector 218 logs impressions regardless of whether the client device 102 provides the device/user identifier 214 in the beacon/impression request 212 (or in response to a request for the identifier 214). When the client device 102 does not provide the device/user identifier 214, the AME impressions collector 218 can still benefit from logging an impression for the media 206 even though it does not have corresponding demographics. For example, the AME 114 may still use the logged impression to generate a total impressions count and/or a frequency of impressions (e.g., an impressions frequency) for the media 206. Additionally or alternatively, the AME 114 may obtain demographics information from the database proprietor 116 for the logged impression if the client device 102 corresponds to a subscriber of the database proprietor 116.

In the illustrated example of FIG. 2, to compare or supplement panelist demographics (e.g., for accuracy or completeness) of the AME 114 with demographics from one or more database proprietors (e.g., the database proprietor 116), the AME impressions collector 218 returns a beacon response message 222 (e.g., a first beacon response) to the client device 102 including an HTTP “302 Found” re-direct message and a URL of a participating database proprietor 116 at, for example, a second Internet domain. In the illustrated example, the HTTP “302 Found” re-direct message in the beacon response 222 instructs the client device 102 to send a second beacon request 226 to the database proprietor 116. In other examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 226) to a participating database proprietor 116. In the illustrated example, the AME impressions collector 218 determines the database proprietor 116 specified in the beacon response 222 using a rule and/or any other suitable type of selection criteria or process. In some examples, the AME impressions collector 218 determines a particular database proprietor to which to redirect a beacon request based on, for example, empirical data indicative of which database proprietor is most likely to have demographic data for a user corresponding to the device/user identifier 214. In some examples, the beacon instructions 208 include a predefined URL of one or more database proprietors to which the client device 102 should send follow up beacon requests 226. In other examples, the same database proprietor is always identified in the first redirect message (e.g., the beacon response 222).

In the illustrated example of FIG. 2, the beacon/impression request 226 may include a device/user identifier 227 that is a DP ID because it is used by the database proprietor 116 to identify a subscriber of the client device 102 when logging an impression. In some instances (e.g., in which the database proprietor 116 has not yet set a DP ID in the client device 102), the beacon/impression request 226 does not include the device/user identifier 227. In some examples, the DP ID is not sent until the database proprietor 116 requests the same (e.g., in response to the beacon/impression request 226). In some examples, the device/user identifier 227 is a device identifier (e.g., an IMEI), an MEID, a MAC address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 116 stores in association with demographic information about subscribers corresponding to the client devices 102. In some examples, the device/user identifier 227 may be encrypted (e.g., hashed) at the client device 102 so that only an intended final recipient of the device/user identifier 227 can decrypt the hashed identifier 227. For example, if the device/user identifier 227 is a cookie that is set in the client device 102 by the database proprietor 116, the device/user identifier 227 can be hashed so that only the database proprietor 116 can decrypt the device/user identifier 227. If the device/user identifier 227 is an IMEI number, the client device 102 can hash the device/user identifier 227 so that only a wireless carrier (e.g., the database proprietor 116) can decrypt the hashed identifier 227 to recover the IMEI for use in accessing demographic information corresponding to the user of the client device 102. By hashing the device/user identifier 227, an intermediate party (e.g., an intermediate server or entity on the Internet) receiving the beacon request cannot directly identify a user of the client device 102. For example, if the intended final recipient of the device/user identifier 227 is the database proprietor 116, the AME 114 cannot recover identifier information when the device/user identifier 227 is hashed by the client device 102 for decrypting only by the intended database proprietor 116.

When the database proprietor 116 receives the device/user identifier 227, the database proprietor 116 can obtain demographic information corresponding to a user of the client device 102 based on the device/user identifier 227 that the database proprietor 116 receives from the client device 102. In some examples, the database proprietor 116 determines (e.g., in accordance with the examples disclosed in U.S. Patent Publication No. 2012/0072469 to Perez et al. and/or U.S. patent application Ser. No. 14/604,394 (now U.S. Patent Publication No. ______), etc.) a set of classification probabilities associated with the user of the client device 102 to include in the demographic information associated with this user. As described above and in further detail below, the set of classification probabilities represent likelihoods that the user belongs to respective ones of a set of possible demographic classifications (e.g., such as likelihoods that the panelist belongs to respective ones of a set of possible age groupings, etc.).

Although only a single database proprietor 116 is shown in FIGS. 1 and 2, the impression reporting/collection process of FIGS. 1 and 2 may be implemented using multiple database proprietors. In some such examples, the beacon instructions 208 cause the client device 102 to send beacon/impression requests 226 to numerous database proprietors. For example, the beacon instructions 208 may cause the client device 102 to send the beacon/impression requests 226 to the numerous database proprietors in parallel or in daisy chain fashion. In some such examples, the beacon instructions 208 cause the client device 102 to stop sending beacon/impression requests 226 to database proprietors once a database proprietor has recognized the client device 102. In other examples, the beacon instructions 208 cause the client device 102 to send beacon/impression requests 226 to database proprietors so that multiple database proprietors can recognize the client device 102 and log a corresponding impression. Thus, in some examples, multiple database proprietors are provided the opportunity to log impressions and provide corresponding demographics information if the user of the client device 102 is a subscriber of services of those database proprietors.

In some examples, prior to sending the beacon response 222 to the client device 102, the AME impressions collector 218 replaces site IDs (e.g., URLs) of media provider(s) that served the media 206 with modified site IDs (e.g., substitute site IDs) which are discernable only by the AME 114 to identify the media provider(s). In some examples, the AME impressions collector 218 may also replace a host website ID (e.g., www.acme.com) with a modified host site ID (e.g., a substitute host site ID) which is discernable only by the AME 114 as corresponding to the host website via which the media 206 is presented. In some examples, the AME impressions collector 218 also replaces the media identifier 213 with a modified media identifier 213 corresponding to the media 206. In this way, the media provider of the media 206, the host website that presents the media 206, and/or the media identifier 213 are obscured from the database proprietor 116, but the database proprietor 116 can still log impressions based on the modified values (e.g., if such modified values are included in the beacon request 226), which can later be deciphered by the AME 114 after the AME 114 receives logged impressions from the database proprietor 116. In some examples, the AME impressions collector 218 does not send site IDs, host site IDS, the media identifier 213 or modified versions thereof in the beacon response 222. In such examples, the client device 102 provides the original, non-modified versions of the media identifier 213, site IDs, host IDs, etc. to the database proprietor 116.

In the illustrated example, the AME impression collector 218 maintains a modified ID mapping table 228 that maps original site IDs with modified (or substitute) site IDs, original host site IDs with modified host site IDs, and/or maps modified media identifiers to the media identifiers such as the media identifier 213 to obfuscate or hide such information from database proprietors such as the database proprietor 116. Also in the illustrated example, the AME impressions collector 218 encrypts all of the information received in the beacon/impression request 212 and the modified information to prevent any intercepting parties from decoding the information. The AME impressions collector 218 of the illustrated example sends the encrypted information in the beacon response 222 to the client device 102 so that the client device 102 can send the encrypted information to the database proprietor 116 in the beacon/impression request 226. In the illustrated example, the AME impressions collector 218 uses an encryption that can be decrypted by the database proprietor 116 site specified in the HTTP “302 Found” re-direct message.

Periodically or aperiodically, the impression data collected by the database proprietor 116 is provided to a DP impressions collector 232 of the AME 114 as, for example, batch data. In some examples, the impression data collected from the database proprietor 116 by the DP impressions collector 232 is demographic impression data, which includes sets of classification probabilities for individuals of a sample population associated with client devices 102 from which beacon requests 226 were received. In some examples, the sets of classification probabilities included in the demographic impression data collected by the DP impressions collector 232 correspond to respective ones of the individuals in the sample population, and may include personal identification capable of identifying the individuals, or may include obfuscated identification information to preserve the anonymity of individuals who are subscribers of the database proprietor. In some examples, the sets of classification probabilities included in the demographic impression data collected by the DP impressions collector 232 correspond to aggregated groups of individuals, which also preserves the anonymity of individuals who are subscribers of the database proprietor.

Additional examples that may be used to implement the beacon instruction processes of FIG. 2 are disclosed in U.S. Pat. No. 8,370,489 to Mainak et al. In addition, other examples that may be used to implement such beacon instructions are disclosed in U.S. Pat. No. 6,108,637 to Blumenau.

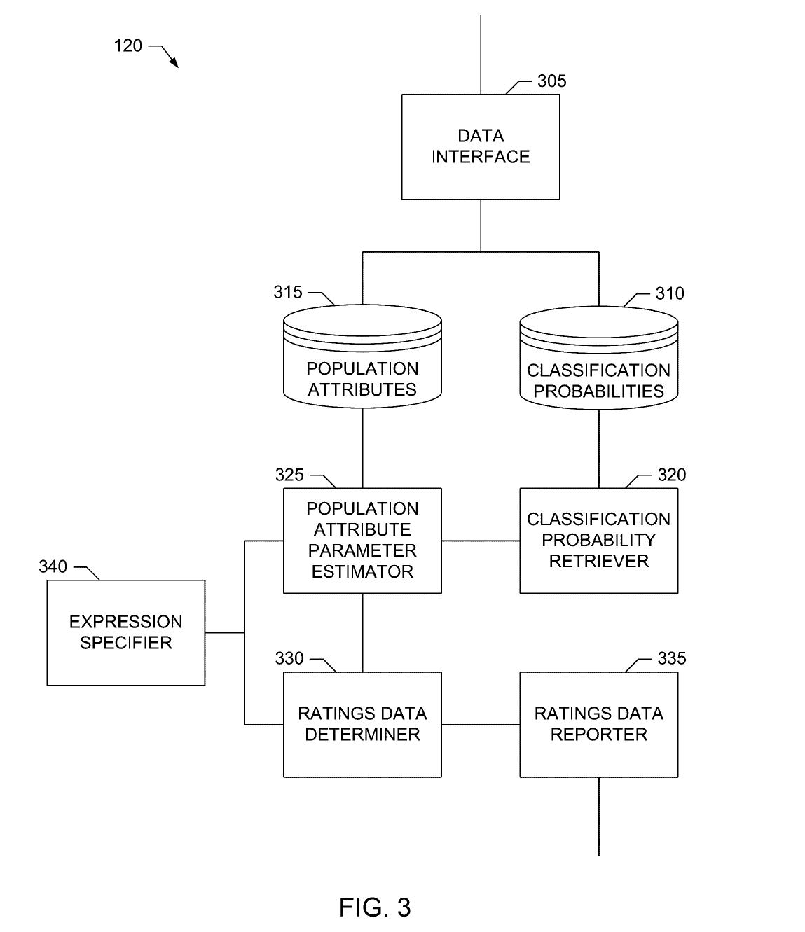

In the example of FIG. 2, the AME 114 includes the example probabilistic ratings determiner 120a to determine ratings data using the sets of classification probabilities determined by the AME impressions collector 218 and/or obtained by the DP impressions collector 232. Additionally or alternatively, in the example of FIG. 2, the database proprietor 116 includes the example probabilistic ratings determiner 120b to determine ratings data using the sets of classification probabilities determined by the database proprietor 116. A block diagram of an example probabilistic ratings determiner 120, which may be used to implement one or both of the example probabilistic ratings determiners 120a and/or 120b, is illustrated in FIG. 3.

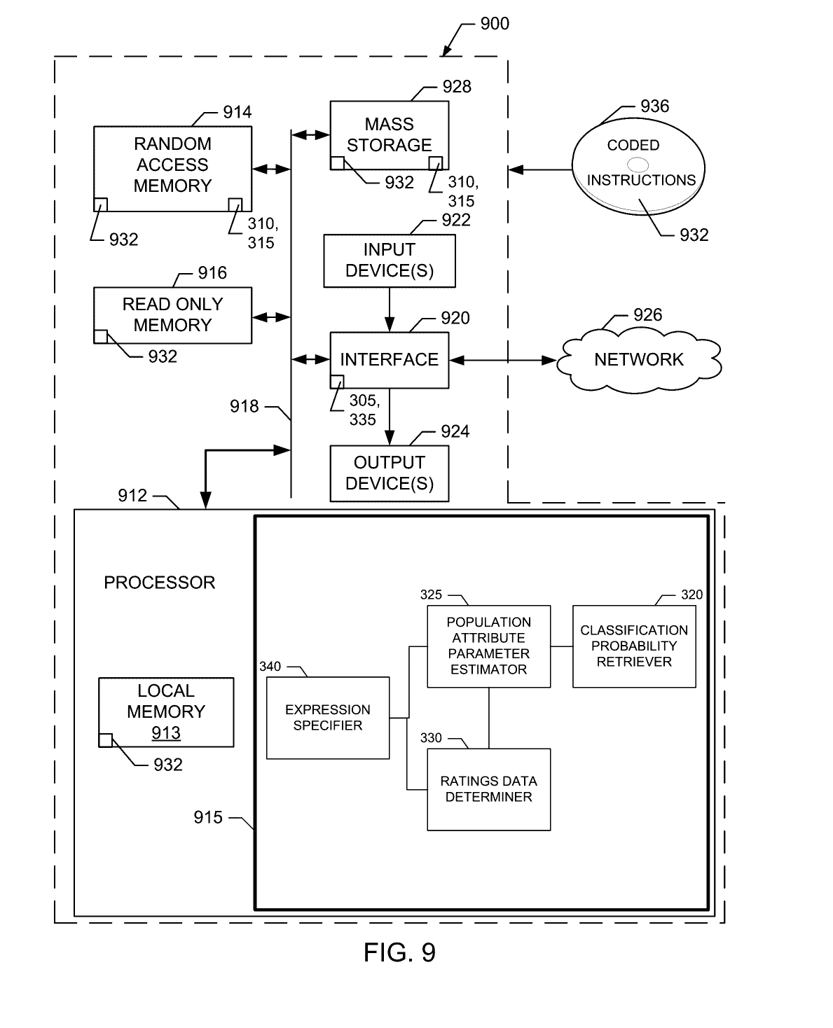

The example probabilistic ratings determiner 120 of FIG. 3 includes an example data interface 305 to interface with the AME impressions collector 218 and/or the DP impressions collector 232 to obtain, for example, population attributes, such as numbers of impressions for given media, and sets of classification probabilities (also referred as classification probability distributions) for individuals in a sample population (e.g., such as individuals associated with the devices 102 sending the beacon requests 108, 212, 226, etc.). The example data interface 305 can be implemented by any type(s), number(s) and/or combination(s) of communication interfaces, network interfaces, etc., such as the example interface circuit 920 of FIG. 9, which is described in further detail below.

The example probabilistic ratings determiner 120 of FIG. 3 also includes an example classification probabilities storage 310 to store the sets of classifications probabilities obtained via the example data interface 305 for different individuals in the sample population. The example probabilistic ratings determiner 120 of FIG. 3 further includes an example population attributes storage 315 to store the population attributes, such as numbers of media impressions, products purchased, services accessed, etc., logged for the different individuals in the sample population. The example classification probabilities storage 310 and/or the example population attributes storage 315 may be implemented by any number(s) and/or type(s) of volatile and/or non-volatile memory, storage, etc., or combination(s) thereof, such as the example volatile memory 914 and/or the example mass storage device(s) 928 of FIG. 9, which is described in further detail below. Furthermore, the example classification probabilities storage 310 and the example population attributes storage 315 may be implemented by the same or different volatile and/or non-volatile memory, storage, etc.

The example probabilistic ratings determiner 120 of FIG. 3 further includes an example classification probability retriever 320 to access sets of classification probabilities stored in the classification probabilities storage 310 for respective individuals in a sample population exposed to media. As described above, a given set of classification probabilities represents likelihoods that a given individual in the sample population belongs to respective ones of a set of possible demographic classifications. For example, the set of possible demographic classifications may correspond to a set of age classifications, also referred to as age buckets, such as a first age bucket including the ages of 10-20 years old, a second age bucket including the ages of 21-30 years old and a third age bucket including the ages of 31-40 years old. In some examples, the set of age classifications (e.g., age buckets) correspond to individual ages (e.g., ages 10, 11, 12, 13, etc.) rather than groups of ages. As an example, the classification probability retriever 320 might access an example set of classification probabilities for an individual named John Smith which includes a first probability of 5% that John Smith belongs to the first age bucket, a second probability of 50% that John Smith belongs to the second age bucket and a third probability of 40% that John Smith belongs to the third age bucket. As another example, the classification probability retriever 320 might retrieve the example sets of classifications probabilities listed in Table 1 for the respective individuals named Alice, Bob and Charlie.

TABLE 1

| Indi- | Attribute | Classification | Classification | Classification |
|---|---|---|---|---|
| vidual | (e.g., | Probability for | Probability for | Probability for |
| Iden- | Number of | First Age | Second Age | Third Age |
| tifier | Impressions) | Bucket | Bucket | Bucket |
| Alice | 100 | 0.44 | 0.49 | 0.07 |
| Bob | 7 | 0.56 | 0.39 | 0.05 |
| Charlie | 20 | 0.16 | 0.31 | 0.53 |

In the example of Table 1, the set of classification probabilities for the individual having the identifier of “Alice” includes a first probability of 0.44 that Alice belongs to the first age bucket, a second probability of 0.49 that Alice belongs to the second age bucket and a third probability of 0.07 that Alice belongs to the third age bucket. In the example of Table 1, the set of classification probabilities for the individual having the identifier of “Bob” includes a first probability of 0.56 that Bob belongs to the first age bucket, a second probability of 0.39 that Bob belongs to the second age bucket and a third probability of 0.05 that Bob belongs to the third age bucket. In the example of Table 1, the set of classification probabilities for the individual having the identifier of “Charlie” includes a first probability of 0.16 that Charlie belongs to the first age bucket, a second probability of 0.31 that Charlie belongs to the second age bucket and a third probability of 0.53 that Charlie belongs to the third age bucket.

In some examples, the individual identifiers associated with the different sets of classifications probabilities are obfuscated to preserve the privacy of the individuals in the sample population. For example, in the example of Table 1, the individual identifiers “Alice,” “Bob” and “Charlie” in the first column of the table could be replaced by the AME 114 and/or the database proprietor 116 with obfuscated identifiers, such as a pseudo-random alphanumeric string determined by processing the individual identifiers with a hash function, a scrambling operation, an encryption procedure, etc. This allows the different sets of classification probabilities to be kept separate and associated with different individuals, but while preserving the privacy of the different individuals.

In some examples, the sets of classification probabilities accessed by the classification probability retriever 320 are associated with aggregated groups of individuals. Example sets of classification probabilities that could be retrieved by the classification probability retriever 320 for aggregated groups of individuals are listed in Table 2.

TABLE 2

| | Attribute | Classification | Classification | Classification |
|---|---|---|---|---|
| Group | (e.g., | Probability for | Probability for | Probability for |
| Iden- | Number of | First Age | Second Age | Third Age |
| tifier | Impressions) | Bucket | Bucket | Bucket |
| Group 1 | 820 | 0.33 | 0.66 | 0.01 |
| Group 2 | 76 | 0.27 | 0.53 | 0.20 |
| Group 3 | 502 | 0.82 | 0.10 | 0.08 |

In the example of Table 2, the set of classification probabilities for the group of individuals having the identifier of “Group 1” includes a first probability of 0.33 that individuals in Group 1 belong to the first age bucket, a second probability of 0.66 that the individuals in Group 1 belong to the second age bucket and a third probability of 0.01 that the individuals in Group 1 belong to the third age bucket. In the example of Table 2, the set of classification probabilities for the group of individuals having the identifier of “Group 2” includes a first probability of 0.27 that individuals in Group 2 belong to the first age bucket, a second probability of 0.53 that the individuals in Group 2 belong to the second age bucket and a third probability of 0.20 that the individuals in Group 2 belong to the third age bucket. In the example of Table 2, the set of classification probabilities for the group of individuals having the identifier of “Group 3” includes a first probability of 0.82 that individuals in Group 3 belong to the first age bucket, a second probability of 0.10 that the individuals in Group 3 belong to the second age bucket and a third probability of 0.08 that the individuals in Group 3 belong to the third age bucket. As can be seen from the example of Table 2, the privacy of each individual is preserved because the classification probabilities are not resolvable down to the user-level.

The example probabilistic ratings determiner 120 of FIG. 3 includes an example population attribute parameter estimator 325 to estimate, based on the sets of classification probabilities accessed by the example classification probability retriever 320, parameters characterizing population attributes associated with the set of possible demographic classifications. Such parameters are also referred to herein as population attribute parameters. Examples of such population attributes include, but are not limited to, numbers of individuals associated with respective ones of the set of possible demographic classifications (e.g., such as numbers of individuals associated with respective age buckets in a set of possible age buckets, etc.), numbers of media impressions associated with the respective ones of the set of possible demographic classifications (e.g., such as numbers of media impressions associated with the respective age buckets in the set of possible age buckets, etc.), etc. In some examples, population attribute parameters estimated by the population attribute parameter estimator 325 are statistical values characterizing different statistical properties of the population attributes (e.g., the numbers of individuals associated with respective ones of the set of possible demographic classifications, the numbers of media impressions associated with the respective ones of the set of possible demographic classifications, etc.) under the assumption that the demographic classifications of individuals (or groups of individuals) in the sample population are governed by the sets of classification probabilities retrieved by the example classification probability retriever 320.

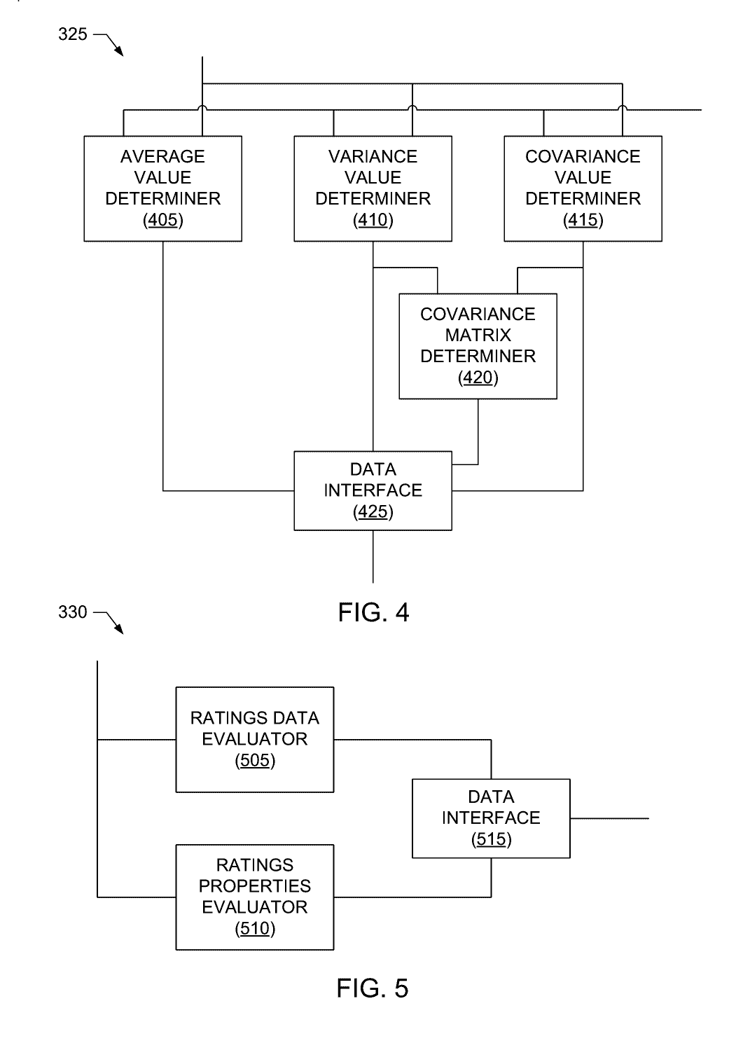

For example, an example implementation of the population attribute parameter estimator 325 of FIG. 3 is illustrated in FIG. 4. (In the illustrated example of FIG. 4, any interfaces between the elements of the population attribute parameter estimator 325 and the example expression specifier 340, which is described in further detail below, are omitted for clarity). The example population attribute parameter estimator 325 is implemented based on using a categorical distribution, which is a probability distribution describing the probability of a random event having one of multiple (e.g., K) possible outcomes, to model the set of classification probabilities representing the likelihoods of a given individual belonging to the different possible demographic classifications. The categorical distribution is a generalization of the Bernoulli distribution, which is a probability distribution describing the probability of a random event having one of two possible outcomes. For a given individual, i, the K possible outcomes of the categorical distribution correspond to K possible demographic classifications (e.g., K possible age buckets), and the probability of the random event having the k^{th} possible outcome corresponds to the classification probability p_{i,k} that the i^{th} individual belongs to the k^{th} possible demographic classification (e.g., the k^{th} possible age bucket). By modeling the sets of classification probabilities for individuals of the sample population as corresponding to categorical distributions, the probabilistic ratings determiner 120 is able to take into account the relationships between and within the different possible demographic classifications, rather than just treating the possible demographic classifications and their associated classification probabilities as being independent from each other.

In the illustrated example of FIG. 4, the population attribute parameter estimator 325 is constructed to estimate parameters characterizing population attributes that are based on sums of individual attributes within respective ones of the different possible demographic classifications. For example, the population attribute parameters estimated by the example population attribute parameter estimator 325 of FIG. 4 may be parameters of (1) a model characterizing numbers (e.g., sums) of individuals associated with respective ones of the set of possible demographic classifications (e.g., such as numbers of individuals associated with respective age buckets in a set of possible age buckets, etc.), (2) a model characterizing numbers (e.g., sums) of media impressions associated with the respective ones of the set of possible demographic classifications (e.g., such as numbers of media impressions associated with the respective age buckets in the set of possible age buckets, etc.), etc. According to the central limit theorem, a sum of independent random variables capable of having one of K possible outcomes may be approximated as random variables having a multivariate normal probability distribution (also referred to as a multivariate Gaussian probability distribution). Thus, assuming that each individual of the sample population behaves independently from each other, the sums of individual attributes within respective ones of the different possible demographic classifications correspond to sums of the categorical distributions used to model the sets of classification probabilities for the individuals of the sample population, which can be modeled as a Poisson-categorical distribution (e.g., a generalization of the Poisson-Binomial distribution), and which may be modeled as a multivariate normal probability distribution.

The multivariate normal probability distribution (as well as the Poisson-categorical distribution) is specified by mean, variance and covariance parameters, which can be determined by estimating the mean values (also referred to as average value or expected values), variance values and covariance values of quantities based on the sum of the categorical distributions, which are independent but not necessarily identically distributed, used to model the sets of classification probabilities for the individuals of the sample population. Accordingly, the example population attribute parameter estimator 325 of FIG. 4 includes an example average value determiner 405 to determine average values for the population attributes associated with respective ones of the set of possible demographic classifications. The example population attribute parameter estimator 325 of FIG. 4 also includes an example variance value determiner 410 to determine variance values for the population attributes associated with respective ones of the set of possible demographic classifications. The example population attribute parameter estimator 325 of FIG. 4 further includes an example covariance value determiner 415 to determine covariance values for the population attributes associated with respective pairs of the set of possible demographic classifications.

For example, when the population attributes for which the population attribute parameter estimator 325 is to estimate parameters include the number of individuals of the sample population belonging to respective ones of the different possible demographic classifications (e.g., different age buckets), the distribution of the random variables Uₖ, which represent the number of individuals Uₖ in the k^{th} demographic classification (e.g., the k^{th} age bucket), can be modeled as having a Poisson-categorical distribution or a multivariate normal probability distribution derived from the sum of independent (but not necessarily identically distributed) categorical distributions represented by the sets of classification probabilities for the different individuals of the sample population. In some such examples, the average value determiner 405 determines the average values, denoted by E[Uₖ], for the population attributes Uₖ (the number of individuals in the k^{th} demographic classification) associated with respective ones of the set of possible demographic classifications using Equation 1, which is:

$$E [ {U}_{k} ] = {\sum }_{n = 1}^{N} {p}_{n , k} \qquad Equation 1$$

In some such examples, the variance value determiner 410 determines the variance values, denoted by Var[Uₖ]=σ² (Uₖ, Uₖ), for the population attributes Uₖ (the number of individuals in the k^{th} demographic classification) associated with respective ones of the set of possible demographic classifications using Equation 2, which is:

$$Var [ {U}_{k} ] = {σ}^{2} ( {U}_{k} , {U}_{k} ) = {\sum }_{n = 1}^{N} ( 1 - {p}_{n , k} ) {p}_{n , k} \qquad Equation 2$$

In some such examples, the covariance value determiner 415 determines the covariance values, denoted by Cov[Uₖ, Uⱼ]=σ² (Uₖ, Uⱼ), for pairs of population attributes Uₖ and Uⱼ (the number of individuals in the k^{th} and j^{th} demographic classifications) associated with respective pairs (e.g., k, j) of the set of possible demographic classifications using Equation 3, which is:

$$Cov [ {U}_{k} , {U}_{j} ] = {σ}^{2} ( {U}_{k} , {U}_{j} ) = - {\sum }_{n = 1}^{N} {p}_{n , k} {p}_{n , j} \qquad Equation 3$$

In Equations 1 through 3, the variable N represents the number of individuals in the sample population, the variable n is an index over the different individuals in the sample population, the variable K is the number of possible demographic classifications (e.g., the number of possible age buckets), the variables k and j are indices over the different possible demographic classifications, the variable p_{n,k} denotes the classification probability representing the likelihood that the n^{th} individual belongs to the k^{th} possible demographic classification, and the variable p_{n,j} denotes the classification probability representing the likelihood that the n^{th} individual belongs to the j^{th} possible demographic classification.

Additionally or alternatively, in examples in which the population attributes for which the population attribute parameter estimator 325 is to estimate parameters include the number of media impressions collected for respective ones of the different possible demographic classifications (e.g., different age buckets), the distribution of the random variables Iₖ, which represent the number of media impressions Iₖ in the k^{th} demographic classification (e.g., the k^{th} age bucket), can be modeled as having a Poisson-categorical distribution or a multivariate normal probability distribution derived from the scaled sum of independent (but not necessarily identically distributed) categorical distributions represented by the sets of classification probabilities for the different individuals of the sample population. In such examples, the categorical distribution for the n^{th} individual of the sample population is scaled based on the number of media impressions, mₙ, associated with that individual. In some such examples, the average value determiner 405 determines the average values, denoted by E[Iₖ], for the population attributes Iₖ (the number of media impressions for the k^{th} demographic classification) associated with respective ones of the set of possible demographic classifications using Equation 4, which is:

$$E [ {I}_{k} ] = {\sum }_{n = 1}^{N} {m}_{n} {p}_{n , k} \qquad Equation 4$$

In some such examples, the variance value determiner 410 determines the variance values, denoted by Var[Iₖ]=σ²(Iₖ, Iₖ), for the population attributes Iₖ (the number of media impressions for the k^{th} demographic classification) associated with respective ones of the set of possible demographic classifications using Equation 5, which is:

$$Var [ {I}_{k} ] = {σ}^{2} ( {I}_{k} , {I}_{k} ) = {\sum }_{n = 1}^{N} {m}_{n}^{2} ( 1 - {p}_{n , k} ) {p}_{n , k} \qquad Equation 5$$

In some such examples, the covariance value determiner 415 determines the covariance values, denoted by Cov[Iₖ, Iⱼ]=σ²(Iₖ, Iⱼ), for the pairs of population attributes Iₖ and Iⱼ (the numbers of media impressions for the k^{th} and j^{th} demographic classifications) associated with respective pairs (e.g., k, j) of the set of possible demographic classifications using Equation 6, which is:

$$Cov [ {I}_{k} , {I}_{j} ] = {σ}^{2} ( {I}_{k} , {I}_{j} ) = - {\sum }_{n = 1}^{N} {m}_{n}^{2} {p}_{n , k} {p}_{n , j} \qquad Equation 6$$

In Equations 4 through 6, the variable N represents the number of individuals in the sample population, the variable n is an index over the different individuals in the sample population, the variable K is the number of possible demographic classifications (e.g., the number of possible age buckets), the variables k and j are indices over the different possible demographic classifications, the variable p_{n,k} denotes the classification probability representing the likelihood that the n^{th} individual belongs to the k^{th} possible demographic classification, and the variable p_{n,j} denotes the classification probability representing the likelihood that the n^{th} individual belongs to the j^{th} possible demographic classification.

The variables used by the example average value determiner 405, the example variance value determiner 410 and the example covariance value determiner 415 to estimate the population attribute parameters of Equations 1 through 6 are summarized in Table 3.

TABLE 3

| Variable | Type | Description |
|---|---|---|
| N | Input | Number of individuals in the sample population |
| K | Input | Number of possible demographic classifications (e.g., the |
| | | number of possible age buckets) |
| n | Index | Index over individuals in the sample population |
| k and j | Indices | Indices over the different possible demographic classifications |
| mₙ | Input | Number of media impressions collected for the n^{th} individual in |
| | | the sample population |
| p_{n, k} | Input | The classification probability representing the likelihood that the |
| | | n^{th} individual belongs to the k^{th} possible demographic |
| | | classification |
| Uₖ | Random | Number of individuals associated with the k^{th} demographic |
| | Variable | classification |
| Iₖ | Random | Number of media impressions associated with the k^{th} |
| | Variable | demographic classification |
| E[Uₖ] | Output | Average value for the number of individuals, Uₖ, in the k^{th} |
| | | demographic classification |
| Var[Uₖ] = | Output | Variance value for the number of individuals, Uₖ, for the k^{th} |
| σ²(Uₖ, Uₖ) | | demographic classification |
| Cov[Uₖ, Uⱼ] = | Output | Covariance value for the numbers of individuals in the k^{th} and j^{th} |
| σ²(Uₖ, Uⱼ) | | demographic classification pair |
| E[Iₖ] | Output | Average value for the number of media impressions, Iₖ, for the |
| | | k^{th} demographic classification |
| Var[Iₖ] = | Output | Variance value for the number of media impressions, Iₖ, for the |
| σ²(Iₖ, Iₖ) | | k^{th} demographic classification |
| Cov[Iₖ, Iⱼ] = | Output | Covariance value for the numbers of media impressions for the |
| σ²(Iₖ, Iⱼ) | | k^{th} and j^{th} demographic classification pair |

In summary, and with reference to Equations 1 and 4, in some examples, the average value determiner 405 determines the average values for the population attributes associated with respective ones of the set of possible demographic classifications by summing first quantities (e.g., p_{n,k} and/or mₙp_{n,k}) based on first classification probabilities (e.g., p_{n,k}), from the sets of classification probabilities, which represent likelihoods that the respective individuals (e.g., n) belong to a first one (e.g., k) of the set of possible demographic classifications (e.g., K), to estimate a first average value (e.g., E[Uₖ] and/or E[Iₖ]) for a first population attribute (e.g., Uₖ and/or Iₖ) associated with the first one (e.g., k) of the set of possible demographic classifications (e.g., K).

In summary, and with reference to Equations 2 and 5, in some examples, the variance value determiner 410 determines the variance values for the population attributes associated with respective ones of the set of possible demographic classifications by summing second quantities (e.g., (1−p_{n,k})p_{n,k} and/or mₙ²(1−p_{n,k})p_{n,k}) based on the first classification probabilities (e.g., p_{n,k}) to estimate a first variance value (e.g., Var[Uₖ]=σ²(Uₖ, Uₖ) and/or Var[Iₖ]=σ² (Iₖ, Iₖ)) for the first population attribute (e.g., Uₖ and/or Iₖ) associated with the first one (e.g., k) of the set of possible demographic classifications (e.g., K).

In summary, and with reference to Equations 3 and 6, in some examples, the covariance value determiner 415 determines the covariance values for the population attributes associated with respective pairs of the set of possible demographic classifications by summing third quantities (e.g., −p_{n,k}p_{n,j} and/or −mₙ²p_{n,k}p_{n,j}) based on the first classification probabilities (e.g., p_{n,k}) and second classification probabilities (e.g., p_{n,j}), from the sets of classification probabilities, representing likelihoods that the respective individuals belong to a second one (e.g., j) of the set of possible demographic classifications (e.g., K) to estimate a first covariance value (e.g., Cov[Uₖ, Uⱼ]=σ²(Uₖ, Uⱼ) and/or Cov[Iₖ, Iⱼ]=σ² (Iₖ, Iⱼ)) for a first pair of population attributes (e.g., Uₖ, Uⱼ and/or Iₖ, Iⱼ) associated with the first and second ones (e.g., k, j) of the set of possible demographic classifications (e.g., K).

In some examples, the population attribute parameter estimator 325 of FIG. 4 further includes an example covariance matrix determiner 420 to form a covariance matrix based on the variance values determined by the example variance value determiner 410 and the covariance values determined by the example covariance value determiner 415. In some such examples, the covariance matrix determiner 420 forms the covariance matrix by including the variance values (e.g., Var[Uₖ]=σ²(Uₖ, Uₖ), Var[Iₖ]=σ² (Iₖ, Iₖ), etc.) determined by the variance value determiner 410 as the on-diagonal elements of the covariance matrix, and including the covariance values (e.g., Cov[Uₖ, Uⱼ]=σ²(Uₖ, Uⱼ), Cov[Iₖ, Iⱼ]=σ²(Iₖ, Iⱼ), etc.) determined by the covariance value determiner 415 as the off-diagonal elements of the covariance matrix. In some examples, the population attribute parameter estimator 325 includes the covariance matrix determiner 420 to permit ratings data to be determined by evaluating a multivariate normal probability distribution having mean values given by the average values determined by the average value determiner 405, and a covariance matrix given by the covariance matrix determined by the covariance matrix determiner 420.

The example population attribute parameter estimator 325 of FIG. 4 also includes an example data interface 425 to output the average values determined by the example average value determiner 405, the variance values determined by the example variance value determiner 410, the covariance values determined by the example covariance value determiner 415, and/or the covariance matrix determined by the example covariance matrix determiner 420. The example data interface 425 can be implemented by any type(s), number(s) and/or combination(s) of communication interfaces, network interfaces, etc., such as the example interface circuit 920 of FIG. 9, which is described in further detail below.

Returning to FIG. 3, the example probabilistic ratings determiner 120 illustrated therein includes an example ratings data determiner 330 to determine ratings data based on the population attribute parameters estimated by the example population attribute parameter estimator 325. An example implementation of the ratings data determiner 330 of FIG. 3 is illustrated in FIG. 5. (In the illustrated example of FIG. 5, any interfaces between the elements of the ratings data determiner 330 and the example expression specifier 340, which is described in further detail below, are omitted for clarity). The example ratings data determiner 330 of FIG. 5 includes an example ratings data evaluator 505 to process the population attribute parameters estimated by the example population attribute parameter estimator 325 to determine ratings data for respective ones and/or combinations of the possible demographic classifications represented by the sets of classification probabilities stored in the classification probabilities storage 310. In some examples, the ratings data evaluator 505 uses the average values determined by the example average value determiner 405 of the population attribute parameter estimator 325 to determine the ratings data for the respective ones and/or combinations of the possible demographic classifications.

For example, if the classification probabilities and population attributes processed by the example population attribute parameter estimator 325 correspond to the example values listed in Table 1 above, the example average value determiner 405 of the population attribute parameter estimator 325 can use Equation 1 and Equation 4 above to determine the average number of individuals and/or the average number of media impressions associated with different demographic classifications (e.g., different age buckets). For example, using Equation 1, the average value determiner 405 can determine the average number of individuals associated with the first age bucket, E[U₁], to be:

E[U₁]=0.44+0.56+0.16=1.16 Equation 7

Additionally or alternatively, using Equation 4, the average value determiner 405 can determine the average number of media impressions associated with the first age bucket, E[U₁], to be:

E[I₁]=(100×0.44)+(7×0.56)+(20×0.16)=51.12 Equation 8

In such an example, the ratings data evaluator 505 may output ratings data including data indicating the average number of individuals associated with the first age group is E[U₁]=1.16 given by Equation 7, and/or data indicating the average number of media impressions associated with the first age group is E[I₁]=51.12 given by Equation 8.

As another example, assume that an online media ratings campaign recorded 10,000 unique individuals, with each individual having a different, respective set of classification probabilities (or, in other words, a different, respective classification probability distribution) stored in the example classification probabilities storage 310. In this example, assume that the sets of classification probabilities are associated with four (4) possible demographic classifications (e.g., 4 possible age buckets). Additionally, assume that numbers of media impressions logged for each one of the individuals is stored in the example population attributes storage 315. Furthermore, assume that the example population attribute parameter estimator 325 uses Equations 1 through 6 above to estimate E[Uₖ] (which is the average number of individuals belonging to respective ones of the different possible demographic classifications), Σ_{U}={σ² (Uₖ, Uⱼ)}|_{k=1 . . . 4,j=1 . . . 4} (which is the covariance matrix for the number of individuals belonging to respective ones of the different possible demographic classifications), I[Uₖ] (which is the average number of media impressions for respective ones of the different possible demographic classifications), and Σ_{I}={σ²(Iₖ, Iⱼ)}|_{k=1 . . . 4,j=1 . . . 4} (which is the covariance matrix for the number of media impressions for respective ones of the different possible demographic classifications) to have values given by Equations 9 through 12, which are:

$$\begin{matrix} E [ U ] = ( \begin{matrix}4184 & 2996 & 1903 & 917\end{matrix} ) & Equation 9 \\ \begin{matrix} {\sum }_{U} = \{ {σ}^{2} ( {U}_{k} , {U}_{j} ) \} {\vert}_{k = 1 … 4 , j = 1 … 4} \\ = ( \begin{matrix}2348 & - 1241 & - 755 & - 352 \\ - 1241 & 2066 & - 563 & - 262 \\ - 755 & - 563 & 1503 & - 185 \\ - 352 & - 262 & - 185 & 798\end{matrix} )\end{matrix} & Equation 10 \\ E [ I ] = ( \begin{matrix}211 \text{,} 658 & 151 \text{,} 926 & 96 \text{,} 661 & 46 \text{,} 328\end{matrix} ) & Equation 11 \\ \{ {σ}^{2} ( {I}_{k} , {I}_{j} ) \} {\vert}_{k = 1 … 4 , j = 1 … 4} = ( \begin{matrix}8 \text{,} 010 \text{,} 060 & - 4 \text{,} 228 \text{,} 951 & - 2 \text{,} 583 \text{,} 705 & - 1 \text{,} 197 \text{,} 404 \\ - 4 \text{,} 228 \text{,} 951 & 7 \text{,} 055 \text{,} 389 & - 1 \text{,} 932 \text{,} 707 & - 893 \text{,} 731 \\ - 2 \text{,} 583 \text{,} 705 & - 1 \text{,} 932 \text{,} 707 & 5 \text{,} 148 \text{,} 646 & - 632 \text{,} 235 \\ - 1 \text{,} 197 \text{,} 404 & - 893 \text{,} 731 & - 632 \text{,} 235 & 2 \text{,} 723 \text{,} 371\end{matrix} ) & Equation 12\end{matrix}$$

In such an example, the ratings data evaluator 505 may output ratings data including the values of Equation 9 as the average numbers of individuals associated with the different possible demographic classifications. In other words, the ratings data evaluator 505 may output E[U₁]=4184 as the average number of individuals associated with the first demographic classification, E[U₂]=2996 as the average number of individuals associated with the second demographic classification, E[U₃]=1903 as the average number of individuals associated with the third demographic classification, and E[U₄]=917 as the average number of individuals associated with the fourth demographic classification. Additionally or alternatively, the ratings data evaluator 505 may output ratings data including the values of Equation 11 as the average numbers of media impressions for the different possible demographic classifications. In other words, the ratings data evaluator 505 may output E[I₁]=211,658 as the average number of media impressions for the first demographic classification, E[I₂]=151,926 as the average number of media impressions for the second demographic classification, E[I₃]=96,661 as the average number of media impressions for the third demographic classification, and E[I₄]=46,328 as the average number of media impressions for the fourth demographic classification.

The example ratings data determiner 330 of FIG. 5 further includes an example ratings properties evaluator 510 to determine, based on the population attribute parameters estimated by the example population attribute parameter estimator 325, statistical values characterizing properties of the ratings data determined by the example ratings data evaluator 505. In some examples, the statistical values determined by the ratings properties evaluator 510 characterize accuracy of the average numbers of individuals determined for the respective ones of the set of possible demographic classifications, and/or accuracy of the average numbers of media impressions determined for the respective ones of the set of possible demographic classifications. Examples of statistical values characterizing the accuracy of the ratings data include confidence intervals, probabilities that ratings data values are less than or greater than threshold values, etc.

In some such examples, the ratings properties evaluator 510 determines, based on the population attribute parameters estimated by the example population attribute parameter estimator 325, a probability that a number of individuals (or a number of media impressions) associated with a first one of a set of possible demographic classifications is less than a threshold value, greater than a threshold value, etc. For example, in the example online media campaign resulting in the example estimated population attribute parameters of Equations 9 through 12, the ratings properties evaluator 510 could use one or more of those parameters to evaluate a normal probability distribution to determine, for example, the probability that the number of individuals belonging to the first age bucket is greater than a threshold value of 4250 (or some other value). In such an example, the ratings properties evaluator 510 uses the estimated average value of 4184 and variance value of 2348 for the first age bucket to model the number of individuals belonging to the first age bucket as a random variable having a normal probability distribution with a mean of 4184 and a variance of 2348, which is represented mathematically as:

X˜N(μ=4184,σ²=2348) Equation 13

Using Equation 13, the ratings properties evaluator 510 can determine the probability that the number of individuals belonging to the first age bucket is greater than the threshold value of 4250 to be:

Pr(X>4,250)=0.0882 Equation 14

Thus, according to Equation 14, the ratings properties evaluator 510 in this example would determine that there is less than a 9% chance that the number of individuals belonging to the first age bucket exceeds 4250.

Additionally or alternatively, in some such examples, the ratings properties evaluator 510 determines, based on the population attribute parameters estimated by the example population attribute parameter estimator 325, a confidence interval for a number of media impressions (or a number of individuals) associated with a first one of a set of possible demographic classifications. For example, in the example online media campaign resulting in the example estimated population attribute parameters of Equations 9 through 12, the ratings properties evaluator 510 could use one or more of those parameters to evaluate a normal probability distribution to determine, for example, the 95% confidence interval (or some other confidence interval) for the number of media impressions for the third age bucket (or some other age bucket). In such an example, the ratings properties evaluator 510 uses the estimated average value of 1903 and variance value of 1503 for the third age bucket to model the number of media impressions for the third age bucket as a random variable having a normal probability distribution with a mean of 96,661 and a variance of 5,148,646, which is represented mathematically as:

X˜N(μ=96,661,σ²=5,148,646) Equation 15

Using Equation 15, the ratings properties evaluator 510 can determine the 95% confidence interval for the number of media impressions for the third age bucket to be:

Pr(5,214≦X≦14,108)=0.95 Equation 16

Thus, according to Equation 16, the ratings properties evaluator 510 in this example would determine that the 95% confidence interval for the number of media impressions for the third age bucket is between 5,214 media impressions and 14,108 media impressions.

Additionally or alternatively, in some such examples, the ratings properties evaluator 510 determines, based on the population attribute parameters estimated by the example population attribute parameter estimator 325, a probability that a number of media impressions (or a number of individuals) associated with a first one of a set of possible demographic classifications is at least one of less than or greater than a combined number of media impressions (or a combined number of individuals) associated with a combination of at least a second one and a third one of the set of possible demographic classifications. Additionally or alternatively, in some such examples, the ratings properties evaluator 510 determines, based on the population attribute parameters estimated by the example population attribute parameter estimator 325, a probability that a combined number of media impressions (or a number of individuals) associated with a first combination (e.g., a first linear combination, with integer and/or non-integer coefficients) of a first group of the possible demographic classifications is at least one of less than, greater than or equal to a combined number of media impressions (or a combined number of individuals) associated with a second combination (e.g., a second linear combination, with integer and/or non-integer coefficients) of a second group of the possible demographic classifications. For example, in the example online media campaign resulting in the example estimated population attribute parameters of Equations 9 through 12, the ratings properties evaluator 510 could use one or more of those parameters to evaluate a normal probability distribution to determine, for example, the probability that the number of media impressions for the first age bucket is greater than the combined number of media impressions for the second and third age buckets. Such a probability is equivalent to the probability that a linear combination of the vector b=[1 −1 −1 0]^{T} with the numbers of media impressions for the different possible age buckets represented in Equations 11 and 12 is greater than 0. In such an example, the ratings properties evaluator 510 uses the average values of Equation 11 and the covariance matrix of Equation 12 to model the linear combination of the vector b with the numbers of media impressions for the different possible age buckets as a random variable having a normal probability distribution given by Equation 17, which is:

X˜N(μ=b^{T}·E[I],σ²=b^{T}·Σ_{I}·b)=X˜N(μ=−36,929,σ²=29,973,995) Equation 17

Using Equation 17, the ratings properties evaluator 510 can determine the probability that the linear combination of the vector b with the numbers of media impressions for the different possible age buckets is greater than zero, which is equivalent to the probability that the number of media impressions for the first age bucket is greater than the combined number of media impressions for the second and third age buckets, to be:

Pr(X>0)=7.6404×10⁻¹² Equation 18

Thus, according to Equation 18, the ratings properties evaluator 510 in this example would determine that the probability that the number of media impressions for the first age bucket is greater than the combined number of media impressions for the second and third age buckets is 7.6404×10⁻¹² or, in other words, is extremely unlikely.

Additionally or alternatively, in some examples, the ratings properties evaluator 510 determines, based on the population attribute parameters estimated by the example population attribute parameter estimator 325, which two possible demographic classifications (e.g., which two possible age buckets) are strongly correlated. In the example online media campaign resulting in the example estimated population attribute parameters of Equations 9 through 12, the ratings properties evaluator 510 could use the media impression covariance matrix of Equation 12 to answer this query. For example, a covariance matrix represented by Σ can be converted to a correlation matrix having elements ρ_{i,j} using Equation 19, which is:

{ρ_{i,j}}=(Σ^{(diag)})^{-1/2}·Σ·(Σ^{(diag)})^{-1/2} Equation 19

Applying Equation 19 to the example media impression covariance matrix of Equation 12 yields the example media impression correlation matrix of Equation 20, which is

$$\{ {ρ}_{i , j} \} {\vert}_{k = 1 … 4 , j = 1 … 4} = ( \begin{matrix}1.0000 & - 0.5625 & - 0.4023 & - 0.2564 \\ - 0.5625 & 1.0000 & - 0.3207 & - 0.2039 \\ - 0.4023 & - 0.3207 & 1.0000 & - 0.1688 \\ - 0.2564 & - 0.2039 & - 0.1688 & 1.0000\end{matrix} ) \qquad Equation 20$$

Equation 20 shows that, for this example, the numbers of media impressions are negatively correlated across different age buckets. In this example, the ratings properties evaluator 510 evaluates the values of the correlation matrix of Equation 20 to identify the off-diagonal value with the largest magnitude, which is −0.5625 corresponding to the correlation between the 1^{st} and 2^{nd} possible demographic classifications (e.g., the 1^{st} and 2^{nd} age buckets). Thus, in this example, the ratings properties evaluator 510 may indicate that the highest correlation occurs between the 1^{st} and 2^{nd} possible demographic classifications (e.g., the 1^{st} and 2^{nd} age buckets).

Additionally or alternatively, in some examples, the ratings properties evaluator 510 adjusts, based on data obtained from one or more other sources, the rating data determined by the example ratings data evaluator 505. For example, the ratings properties evaluator 510 may obtain data from another source confirming that one of the possible demographic classifications (e.g., one of the possible age buckets) includes exactly P individuals. In some such examples, the ratings properties evaluator 510 evaluates one or more appropriate conditional probability distributions, which are known to persons having ordinary skill in the art, using this new information and one or more of the population attribute parameters estimated by the example population attribute parameter estimator 325 to adjust the ratings data (e.g., the numbers of individuals determined to belong to others of the possible demographic classifications) determined by the example ratings data evaluator 505.

The example population attribute parameter estimator 325 of FIG. 4 also includes an example data interface 515 to output the data determined by the example ratings data evaluator 505 and/or the example ratings properties evaluator 510. The example data interface 515 can be implemented by any type(s), number(s) and/or combination(s) of communication interfaces, network interfaces, etc., such as the example interface circuit 920 of FIG. 9, which is described in further detail below.

Returning to FIG. 3, the example probabilistic ratings determiner 120 illustrated therein includes an example ratings data reporter 335 to transmit the ratings data determined by the example ratings data determiner 330 to one or more recipients. For example, the ratings data reporter 335 can be configured to transmit the ratings data electronically to a media provider that provided the media corresponding to the media impressions logged for an online media ratings campaign. In some examples, the ratings data reporter 335 reports the ratings data periodically, aperiodically, based on occurrence of an event (e.g., receipt of a request for ratings data, when a storage buffer becomes full, etc.), etc. The example ratings data reporter 335 can be implemented by any type(s), number(s) and/or combination(s) of communication interfaces, network interfaces, etc., such as the example interface circuit 920 of FIG. 9, which is described in further detail below.

The example probabilistic ratings determiner 120 of FIG. 3 also includes an example expression specifier 340 to permit user configuration of, for example, the population attribute parameter estimator 325 and/or the ratings data determiner 330. In some examples, the expression specifier 340 permits specification of one or more mathematical expressions, such as the expressions of Equations 1-6, 13, 15, 17, 19, etc., to be evaluated by the population attribute parameter estimator 325 and/or the ratings data determiner 330 to estimate population attribute parameters and/or to determine ratings data. Additionally or alternatively, in some examples, the expression specifier 340 permits specification of user inputs to one or more of those mathematical expressions. In some examples, the expression specifier 340 accepts and processing scripts specifying such mathematical expressions and/or inputs to those expressions. Such scripts may conform to one or more scripting computer languages, such as, but not limited to, JavaScript, Jscript, Python, Perl, etc.

Although the example probabilistic ratings determiners 120, 120a and 120b of FIGS. 1-5 have been described primarily from the perspective of determining ratings data based on logged media impressions for online media, the example methods, apparatus, systems and articles of manufacture (e.g., physical storage media) disclosed herein to determine ratings data from population sample data having unreliable demographic classifications are not limited thereto. On the contrary, the example probabilistic ratings determiners 120, 120a and 120b can determine ratings data from any type of population sample data having unreliable demographic classifications. For example, the example probabilistic ratings determiners 120, 120a and 120b can determine ratings data for population sample data logging and/or otherwise representing population attributes such as, but not limited to, media impressions, products purchased, services accessed, etc. In some such examples, the example probabilistic ratings determiners 120, 120a and 120b can determine ratings data for such population attributes by using the variable mₙ of Equations 4-6 to represent the population attribute (e.g., per individual n) for which ratings data is to be determined. For example, the logged impressions could correspond to numbers of products purchased per individual, the demographic buckets could correspond to different stores, and the classifications probabilities could represent the likelihoods that respective individuals purchased their products from the respective different stores. In such an example, the example probabilistic ratings determiners 120, 120a and 120b can determine, for example, the expected numbers of individuals visiting the different stores, the expected numbers of products purchased from the different stores, etc.

While example manners of implementing the example probabilistic ratings determiners 120, 120a and 120b are illustrated in FIGS. 1-5, one or more of the elements, processes and/or devices illustrated in FIGS. 1-5 may be combined, divided, re-arranged, omitted, eliminated and/or implemented in any other way. Further, the example data interface 305, the example classification probabilities storage 310, the example population attributes storage 315, the example classification probability retriever 320, the example population attribute parameter estimator 325, the example ratings data determiner 330, the example ratings data reporter 335, the example expression specifier 340, the example average value determiner 405, the example variance value determiner 410, the example covariance value determiner 415, the example covariance matrix determiner 420, the example data interface 425, the example ratings data evaluator 505, the example ratings properties evaluator 510, the example data interface 515 and/or, more generally, the example probabilistic ratings determiners 120, 120a and/or 120b of FIGS. 1-5 may be implemented by hardware, software, firmware and/or any combination of hardware, software and/or firmware. Thus, for example, any of the example data interface 305, the example classification probabilities storage 310, the example population attributes storage 315, the example classification probability retriever 320, the example population attribute parameter estimator 325, the example ratings data determiner 330, the example ratings data reporter 335, the example expression specifier 340, the example average value determiner 405, the example variance value determiner 410, the example covariance value determiner 415, the example covariance matrix determiner 420, the example data interface 425, the example ratings data evaluator 505, the example ratings properties evaluator 510, the example data interface 515 and/or, more generally, the example probabilistic ratings determiners 120, 120a and/or 120b could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example probabilistic ratings determiners 120, 120a and/or 120b, the example data interface 305, the example classification probabilities storage 310, the example population attributes storage 315, the example classification probability retriever 320, the example population attribute parameter estimator 325, the example ratings data determiner 330, the example ratings data reporter 335, the example expression specifier 340, the example average value determiner 405, the example variance value determiner 410, the example covariance value determiner 415, the example covariance matrix determiner 420, the example data interface 425, the example ratings data evaluator 505, the example ratings properties evaluator 510 and/or the example data interface 515 is/are hereby expressly defined to include a tangible computer readable storage device or storage disk such as a memory, a digital versatile disk (DVD), a compact disk (CD), a Blu-ray disk, etc. storing the software and/or firmware. Further still, the example probabilistic ratings determiners 120, 120a and/or 120b may include one or more elements, processes and/or devices in addition to, or instead of, those illustrated in FIGS. 1-5, and/or may include more than one of any or all of the illustrated elements, processes and devices.

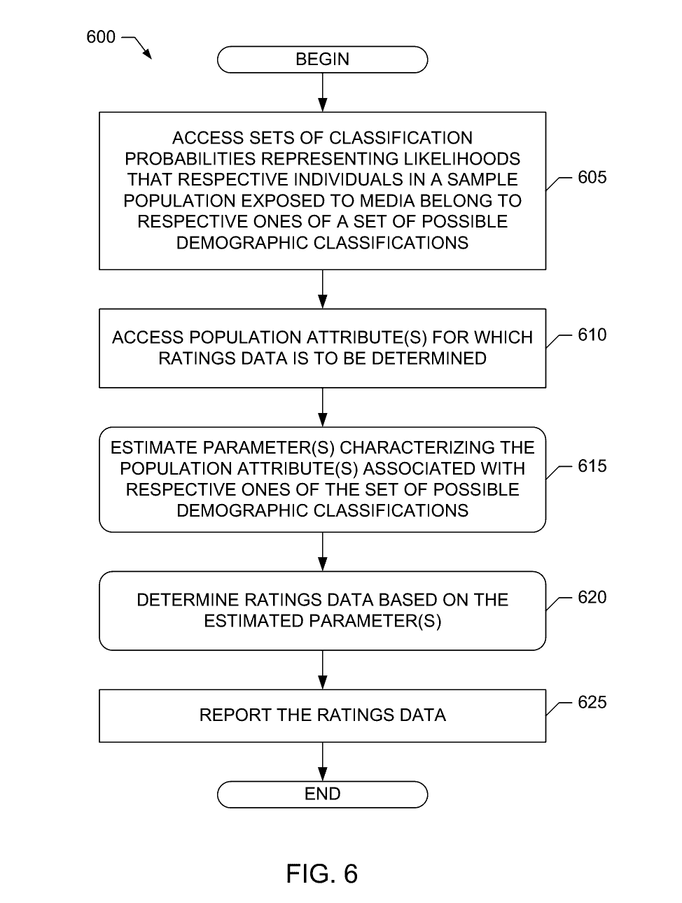

Flowcharts representative of example machine readable instructions for implementing the example probabilistic ratings determiners 120, 120a and/or 120b, the example data interface 305, the example classification probabilities storage 310, the example population attributes storage 315, the example classification probability retriever 320, the example population attribute parameter estimator 325, the example ratings data determiner 330, the example ratings data reporter 335, the example expression specifier 340, the example average value determiner 405, the example variance value determiner 410, the example covariance value determiner 415, the example covariance matrix determiner 420, the example data interface 425, the example ratings data evaluator 505, the example ratings properties evaluator 510 and/or the example data interface 515 are shown in FIGS. 6-8. In these examples, the machine readable instructions comprise one or more programs for execution by a processor, such as the processor 912 shown in the example processor platform 900 discussed below in connection with FIG. 9. The one or more programs, or portion(s) thereof, may be embodied in software stored on a tangible computer readable storage medium such as a CD-ROM, a floppy disk, a hard drive, a digital versatile disk (DVD), a Blu-ray Disk™, or a memory associated with the processor 912, but the entire program or programs and/or portions thereof could alternatively be executed by a device other than the processor 912 and/or embodied in firmware or dedicated hardware (e.g., implemented by an ASIC, a PLD, an FPLD, discrete logic, etc.). Further, although the example program(s) is(are) described with reference to the flowcharts illustrated in FIGS. 6-8, many other methods of implementing the example probabilistic ratings determiners 120, 120a and/or 120b, the example data interface 305, the example classification probabilities storage 310, the example population attributes storage 315, the example classification probability retriever 320, the example population attribute parameter estimator 325, the example ratings data determiner 330, the example ratings data reporter 335, the example expression specifier 340, the example average value determiner 405, the example variance value determiner 410, the example covariance value determiner 415, the example covariance matrix determiner 420, the example data interface 425, the example ratings data evaluator 505, the example ratings properties evaluator 510 and/or the example data interface 515 may alternatively be used. For example, with reference to the flowcharts illustrated in FIGS. 6-8, the order of execution of the blocks may be changed, and/or some of the blocks described may be changed, eliminated, combined and/or subdivided into multiple blocks.

As mentioned above, the example processes of FIGS. 6-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 6-8 may be implemented using coded instructions (e.g., computer and/or machine readable instructions) stored on a non-transitory computer and/or machine readable medium such as a hard disk drive, a flash memory, a ROM, a CD, a DVD, a cache, a RAM and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the terms “comprising” and “including” are open ended. Also, as used herein, the terms “computer readable” and “machine readable” are considered equivalent unless indicated otherwise.

An example program 600 that may be executed to implement the example probabilistic ratings determiners 120, 120a and/or 120b of FIGS. 1-5 is represented by the flowchart shown in FIG. 6. For convenience, and without loss of generality, the example program 600 is described from the perspective of execution by the example probabilistic ratings determiner 120. With reference to the preceding figures and associated written descriptions, the example program 600 of FIG. 6 begins execution at block 605 at which the example classification probability retriever 320 of the probabilistic ratings determiner 120 accesses (e.g., from the example classification probabilities storage 310, as described above) sets of classification probabilities representing likelihoods that respective individuals in a sample population exposed to media belong to respective ones of a set of possible demographic classifications. At block 610, the example population attribute parameter estimator 325 of the probabilistic ratings determiner 120 accesses (e.g., from the example population attributes storage 315, as described above) one or more population attributes for which ratings data is to be determined. For example, such population attributes may include, but are not limited to, numbers of media impressions associated with (e.g., logged for) respective ones of the individuals in the sample population, existence of an individual in the sample population (e.g., when the ratings data is to indicate numbers of individuals belonging to different demographic classifications), etc.

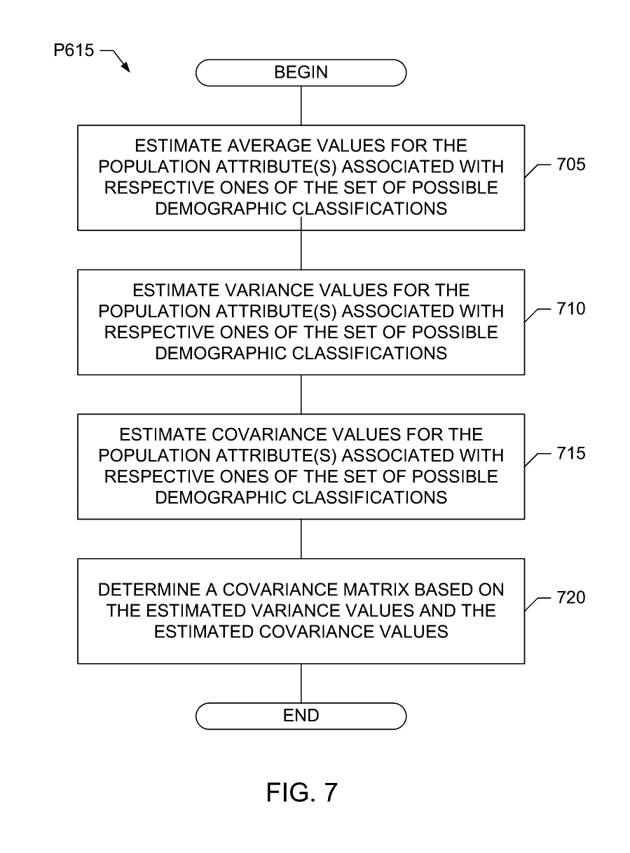

At block 615, the example population attribute parameter estimator 325 estimates, as described above and based on the sets of classification probabilities accessed at block 605, one or more parameters characterizing the population attribute(s) associated with respective ones of the set of possible demographic classifications. Example machine readable instructions that may be executed to perform the processing at block 615 are illustrated in FIG. 7.

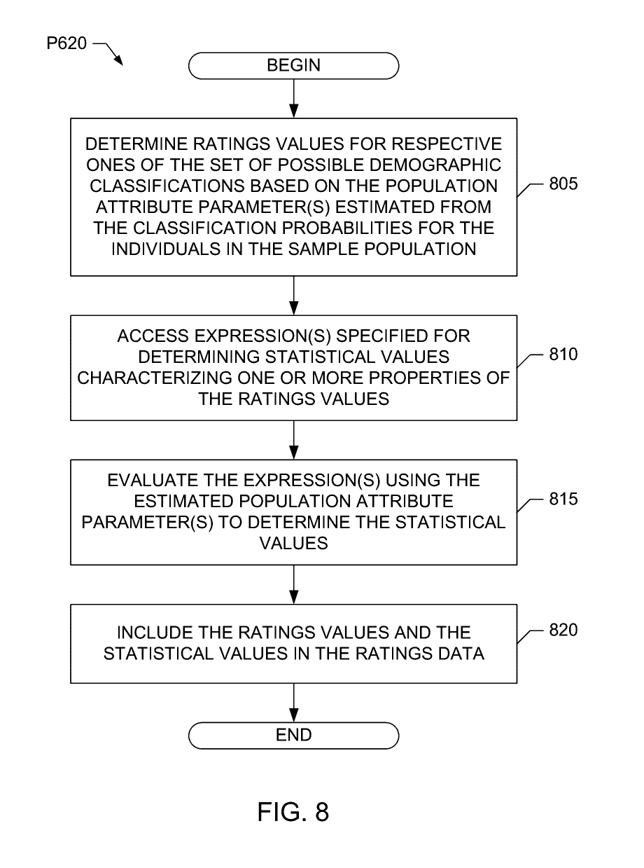

At block 620, the example ratings data determiner 330 of the probabilistic ratings determiner 120 determines, as described above, ratings data based on the population attribute parameter(s) estimated at block 615. Example machine readable instructions that may be executed to perform the processing at block 620 are illustrated in FIG. 8.

At block 625, the example ratings data reporter 335 of the probabilistic ratings determiner 120 reports, as described above, the ratings data determined at block 620. For example, at block 625 the ratings data reporter 335 may transmit the ratings data electronically to a provider of the media to which the sample population was exposed.

An example program P615 that may be executed to implement the example population attribute parameter estimator 325 of FIG. 3 and/or to perform the processing at block 615 of FIG. 6 is represented by the flowchart shown in FIG. 7. With reference to the preceding figures and associated written descriptions, the example program P615 of FIG. 7 begins execution at block 705 at which the example average value determiner 405 of the population attribute parameter estimator 325 estimates, based on sets of classification probabilities as described above, average values (also referred to as mean values, expected values, etc.) for population attributes associated with respective ones of a set of possible demographic classifications. At block 710, the example variance value determiner 410 of the population attribute parameter estimator 325 estimates, based on the sets of classification probabilities as described above, variance values for the population attributes associated with the respective ones of the set of possible demographic classifications. At block 715, the example covariance value determiner 415 of the population attribute parameter estimator 325 estimates, based on the sets of classification probabilities as described above, covariance values for the population attributes associated with respective pairs of the set of possible demographic classifications. In some examples, at block 720, the example covariance matrix determiner 420 of the population attribute parameter estimator 325 constructs, as described above, a covariance matrix based on the variance values determined at block 710 and the covariance values determined at block 715.

An example program P620 that may be executed to implement the example ratings data determiner 330 of FIG. 3 and/or to perform the processing at block 620 of FIG. 6 is represented by the flowchart shown in FIG. 8. With reference to the preceding figures and associated written descriptions, the example program P620 of FIG. 8 begins execution at block 805 at which the example ratings data evaluator 505 of the ratings data determiner 330 determines, as described above, ratings values (e.g., number of individuals, numbers of media impressions, etc.) for respective ones of a set of possible demographic classifications based on one or more population attribute parameters (e.g., such as estimated average/expected value(s)) estimated from the sets of classification probabilities for the individuals in the sample population.

At block 810, the example ratings properties evaluator 510 of the ratings data determiner 330 accessed one or more expressions specified (e.g., by the example expression specifier 340) for determining one or more statistical values characterizing one or more properties of the ratings values determined at block 810. Examples of such expressions include, but are not limited to, the example expressions set forth in Equations 13, 15, 17, 19, etc., and which may characterize, for example, accuracy of the ratings values determined at block 805, relationships between the ratings values determined for different demographic classifications at block 805, etc. At block 815, the ratings properties evaluator 510 evaluates the expressions using one or more estimated population attribute parameters (e.g., one or more of the average/expected values, the variance values, the covariance values and/or the covariance matrix determined by the example population attribute parameter estimator 325) to determine the statistical value(s) characterizing the ratings values determined at block 805. At block 820, the ratings data evaluator 505 and the ratings properties evaluator 510 include the ratings values determined at block 805 and the statistical values determined at block 815 in the ratings data to be reported to one or more recipients.

FIG. 9 is a block diagram of an example processor platform 900 structured to execute the instructions of FIGS. 6, 7 and/or 8 to implement the example probabilistic ratings determiners 120, 120a and/or 120b of FIGS. 1-5. The processor platform 900 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a digital camera, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. In the illustrated example of FIG. 9, the processor 912 includes one or more example processing cores 915 configured via example instructions 932, which include the example instructions of FIGS. 6, 7 and/or 8, to implement the example classification probability retriever 320, the example population attribute parameter estimator 325, the example ratings data determiner 330 and/or the example expression specifier 340 of FIGS. 3-5.

The processor 912 of the illustrated example includes a local memory 913 (e.g., a cache). The processor 912 of the illustrated example is in communication with a main memory including a volatile memory 914 and a non-volatile memory 916 via a link 918. The link 918 may be implemented by a bus, one or more point-to-point connections, etc., or a combination thereof. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 900, can allow the user to control the computer system and provide data to the computer using physical gestures, such as, but not limited to, hand or body movements, facial expressions, and face recognition.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.). In the illustrated example of FIG. 9, the interface circuit 920 is also structured to implement one or more of the example data interface 305, the example ratings data reporter 335, the example data interface 425 and/or the example data interface 515 of FIGS. 3-5.

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID (redundant array of independent disks) systems, and digital versatile disk (DVD) drives. In some examples, the mass storage device 930 may implement the example classification probabilities storage 310 and/or the example population attributes storage 315. Additionally or alternatively, in some examples the volatile memory 918 may implement the example classification probabilities storage 310 and/or the example population attributes storage 315.

Coded instructions 932 corresponding to the instructions of FIGS. 6, 7 and/or 8 may be stored in the mass storage device 928, in the volatile memory 914, in the non-volatile memory 916, in the local memory 913 and/or on a removable tangible computer readable storage medium, such as a CD or DVD 936.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to determine ratings data for media exposure, the method comprising:
accessing, with a processor, sets of classification probabilities for respective individuals in a sample population exposed to media, a first one of the sets of classification probabilities representing likelihoods that a first one of the individuals belongs to respective ones of a set of possible demographic classifications; and
estimating, with the processor and based on the sets of classification probabilities, parameters characterizing population attributes associated with the set of possible demographic classifications; and
determining, with the processor, the ratings data based on the estimated parameters.

2. A method as defined in claim 1, wherein the first one of the sets of classification probabilities includes a first probability that the first one of the individuals belongs to a first one of the set of possible demographic classifications and a second probability that the first one of the individuals belongs to a second one of the set of possible demographic classifications.

3. A method as defined in claim 1, wherein the parameters include:
average values for the population attributes associated with respective ones of the set of possible demographic classifications;
variance values for the population attributes associated with the respective ones of the set of possible demographic classifications; and
covariance values for the population attributes associated with respective pairs of the set of possible demographic classifications.

4. A method as defined in claim 3, wherein estimating the parameters includes:
summing first quantities based on first classification probabilities, from the sets of classification probabilities, representing likelihoods that the respective individuals belong to a first one of the set of possible demographic classifications to estimate a first average value for a first population attribute associated with the first one of the set of possible demographic classifications;
summing second quantities based on the first classification probabilities to estimate a first variance value for the first population attribute associated with the first one of the set of possible demographic classifications; and
summing third quantities based on the first classification probabilities and second classification probabilities, from the sets of classification probabilities, representing likelihoods that the respective individuals belong to a second one of the set of possible demographic classifications to estimate a first covariance value for a first pair of population attributes associated with the first and second ones of the set of possible demographic classifications.

5. A method as defined in claim 3, wherein estimating the parameters includes forming a covariance matrix based on the variance values and the covariance values, and determining the ratings data includes using the average values and the covariance matrix to evaluate an expression based on a multivariate normal distribution to determine the ratings data.

6. A method as defined in claim 1, wherein the population attributes associated with the set of possible demographic classification include at least one of numbers of individuals associated with respective ones of the set of possible demographic classifications or numbers of media impressions associated with the respective ones of the set of possible demographic classifications.

7. A method as defined in claim 6, wherein determining the ratings data includes at least one of:
determining, based on the estimated parameters, a probability that a number of individuals associated with a first one of the set of possible demographic classifications is at least one of less than or greater than a value;
determining, based on the estimated parameters, a confidence interval for a number of media impressions associated with the first one of the set of possible demographic classifications; or
determining, based on the estimated parameters, a probability that the number of media impressions associated with the first one of the set of possible demographic classifications is at least one of less than or greater than a combined number of media impressions associated with a combination of at least a second one and a third one of the set of possible demographic classifications.

8. A method as defined in claim 6, wherein determining the ratings data includes:
determining, based on the estimated parameters, at least one of average numbers of individuals associated with the respective ones of the set of possible demographic classifications or average numbers of media impressions associated with the respective ones of the set of possible demographic classifications to include in the ratings data; and
determining, based on the estimated parameters, statistical values characterizing accuracy of the least one of the determined average numbers of individuals associated with the respective ones of the set of possible demographic classifications or the determined average numbers of media impressions associated with the respective ones of the set of possible demographic classifications to include in the ratings data; and
the method further includes transmitting the ratings data electronically from the processor to a provider of the media.

9. A tangible computer readable storage medium comprising computer readable instructions which, when executed, cause a processor to at least:
access sets of classification probabilities for respective individuals in a sample population exposed to media, a first one of the sets of classification probabilities representing likelihoods that a first one of the individuals belongs to respective ones of a set of possible demographic classifications; and
estimate, based on the sets of classification probabilities, parameters characterizing population attributes associated with the set of possible demographic classifications; and
determine ratings data based on the estimated parameters.

10. A storage medium as defined in claim 9, wherein the parameters include:
average values for the population attributes associated with respective ones of the set of possible demographic classifications;
variance values for the population attributes associated with the respective ones of the set of possible demographic classifications; and
covariance values for the population attributes associated with respective pairs of the set of possible demographic classifications.

11. A storage medium as defined in claim 10, wherein to estimate the parameters, the computer readable instructions, when executed, further cause the processor to:
sum first quantities based on first classification probabilities, from the sets of classification probabilities, representing likelihoods that the respective individuals belong to a first one of the set of possible demographic classifications to estimate a first average value for a first population attribute associated with the first one of the set of possible demographic classifications;
sum second quantities based on the first classification probabilities to estimate a first variance value for the first population attribute associated with the first one of the set of possible demographic classifications; and
sum third quantities based on the first classification probabilities and second classification probabilities, from the sets of classification probabilities, representing likelihoods that the respective individuals belong to a second one of the set of possible demographic classifications to estimate a first covariance value for a first pair of population attributes associated with the first and second ones of the set of possible demographic classifications.

12. A storage medium as defined in claim 9, wherein the population attributes associated with the set of possible demographic classification include at least one of numbers of individuals associated with respective ones of the set of possible demographic classifications or numbers of media impressions associated with the respective ones of the set of possible demographic classifications.

13. A storage medium as defined in claim 12, wherein to determine the ratings data, the computer readable instructions, when executed, further cause the processor to at least one of:
determine, based on the estimated parameters, a probability that a number of individuals associated with a first one of the set of possible demographic classifications is at least one of less than or greater than a value;
determine, based on the estimated parameters, a confidence interval for a number of media impressions associated with the first one of the set of possible demographic classifications; or
determine, based on the estimated parameters, a probability that the number of media impressions associated with the first one of the set of possible demographic classifications is at least one of less than or greater than a combined number of media impressions associated with a combination of at least a second one and a third one of the set of possible demographic classifications.

14. A storage medium as defined in claim 9, wherein to determine the ratings data, the computer readable instructions, when executed, further cause the processor to
determine, based on the estimated parameters, at least one of average numbers of individuals associated with the respective ones of the set of possible demographic classifications or average numbers of media impressions associated with the respective ones of the set of possible demographic classifications to include in the ratings data; and
determine, based on the estimated parameters, statistical values characterizing accuracy of the least one of the determined average numbers of individuals associated with the respective ones of the set of possible demographic classifications or the determined average numbers of media impressions associated with the respective ones of the set of possible demographic classifications to include in the ratings data; and
the computer readable instructions, when executed, further cause the processor to transmit the ratings data electronically from the processor to a provider of the media.

15. An apparatus to determine ratings data for media exposure, the apparatus comprising:
a classification probability retriever to access sets of classification probabilities for respective individuals in a sample population exposed to media, a first one of the sets of classification probabilities representing likelihoods that a first one of the individuals belongs to respective ones of a set of possible demographic classifications; and
a population attribute parameter estimator to estimate, based on the sets of classification probabilities, parameters characterizing population attributes associated with the set of possible demographic classifications; and
a ratings data determiner to determine the ratings data based on the estimated parameters.

16. An apparatus as defined in claim 15, wherein the parameters include:
average values for the population attributes associated with respective ones of the set of possible demographic classifications;
variance values for the population attributes associated with the respective ones of the set of possible demographic classifications; and
covariance values for the population attributes associated with respective pairs of the set of possible demographic classifications.

17. An apparatus as defined in claim 16, wherein the population attribute parameter estimator is further to:
sum first quantities based on first classification probabilities, from the sets of classification probabilities, representing likelihoods that the respective individuals belong to a first one of the set of possible demographic classifications to estimate a first average value for a first population attribute associated with the first one of the set of possible demographic classifications;
sum second quantities based on the first classification probabilities to estimate a first variance value for the first population attribute associated with the first one of the set of possible demographic classifications; and
sum third quantities based on the first classification probabilities and second classification probabilities, from the sets of classification probabilities, representing likelihoods that the respective individuals belong to a second one of the set of possible demographic classifications to estimate a first covariance value for a first pair of population attributes associated with the first and second ones of the set of possible demographic classifications.

18. An apparatus as defined in claim 15, wherein the population attributes associated with the set of possible demographic classification include at least one of numbers of individuals associated with respective ones of the set of possible demographic classifications or numbers of media impressions associated with the respective ones of the set of possible demographic classifications.

19. An apparatus as defined in claim 18, wherein the ratings data determiner is further to at least one of:
determine, based on the estimated parameters, a probability that a number of individuals associated with a first one of the set of possible demographic classifications is at least one of less than or greater than a value;
determine, based on the estimated parameters, a confidence interval for a number of media impressions associated with the first one of the set of possible demographic classifications; or
determine, based on the estimated parameters, a probability that the number of media impressions associated with the first one of the set of possible demographic classifications is at least one of less than or greater than a combined number of media impressions associated with a combination of at least a second one and a third one of the set of possible demographic classifications.

20. An apparatus as defined in claim 15, wherein the ratings data determiner is further to:
determine, based on the estimated parameters, at least one of average numbers of individuals associated with the respective ones of the set of possible demographic classifications or average numbers of media impressions associated with the respective ones of the set of possible demographic classifications to include in the ratings data; and
determine, based on the estimated parameters, statistical values characterizing accuracy of the least one of the determined average numbers of individuals associated with the respective ones of the set of possible demographic classifications or the determined average numbers of media impressions associated with the respective ones of the set of possible demographic classifications to include in the ratings data; and
the further includes a ratings data reporter to transmit the ratings data electronically from the processor to a provider of the media.
